(19) United States
(12) Patent Application Publication
(10) Pub. No.: US 2011/0228019 A1
(43) Pub. Date: Sep. 22, 2011

(54) INK CARTRIDGE

(75) Inventors: Noritsugu ITO, Tokoname-shi (JP); Mikio HIRANO, Obu-shi (JP)

(73) Assignee: Brother Kogyo Kabushiki Kaisha, Nagoya-shi (JP)

(21) Appl. No.: 13/011,647

(22) Filed: Jan. 21, 2011

(30) Foreign Application Priority Data
Jan. 22, 2010 (JP) 2010-011801

(51) Int. Cl. B41J 2/175

(52) U.S. Cl. 347/86

(57) ABSTRACT

An ink cartridge includes an ink storing portion configured to store ink therein, an ink outlet path configured to place an interior of the ink storing portion in fluid communication with an exterior of the ink storing portion, a particular valve disposed at the ink outlet path configured to selectively close the ink outlet path, and a further valve. The further valve is disposed at the ink outlet path. The further valve includes a valve seat separately formed from the particular valve, and a further valve member that closes the further valve when the further valve member contacts the valve seat. The further valve member is urged against the valve seat toward the particular valve when the further valve is closed.

### CROSS REFERENCE TO RELATED APPLICATION

This application claims priority to Japanese Patent Application No. 2010-011801, filed Jan. 22, 2010, the entire subject matter and disclosure of which is incorporated herein by reference.

### BACKGROUND OF THE INVENTION

1. Field of the Invention

The present invention relates to an ink cartridge.

2. Description of Related Art

A known ink cartridge has an ink bag and a valve for selectively supplying ink stored in the ink bag to an outside of the ink cartridge. The valve has a spring, spring seat, and a lid. An ink supply needle provided in an ink jet recording apparatus is inserted through the lid and contacts and moves the spring seat, such that ink stored in the ink bag flows through the ink supply needle and is supplied to the ink jet recording apparatus.

However, the lid may be damaged by the ink supply needle, and ink may leak out of the ink cartridge via the lid when and/or after the ink supply needle is pulled out of the lid.

### SUMMARY OF THE INVENTION

Therefore, a need has arisen for an ink cartridge which overcomes these and other shortcomings of the related art. A technical advantage of the present invention is that leakage of liquid is reduced when a valve of a liquid cartridge is damaged.

In an embodiment of the invention, an ink cartridge comprises an ink storing portion configured to store ink therein, and an ink outlet tube forming an ink outlet path configured to place an interior of the ink storing portion in fluid communication with an exterior of the ink storing portion. The ink outlet tube comprises a first outlet tube portion and a second outlet tube portion. The ink cartridge also comprises a particular valve comprising a sealing member configured to selectively close the particular valve by elastically deforming and reforming, and disposed at the first outlet tube portion, and a further valve disposed at the second outlet tube portion in the ink outlet path. The further valve comprises a further valve seat disposed at the second outlet tube portion separately formed from the sealing member and integrally formed with the second outlet tube portion, such that the further valve seat forms at least a portion of a wall at the second outlet tube portion, a further valve member disposed at the second outlet tube portion, and configured to selectively contact and separate away from the further valve seat, to close and open the further valve, respectively, wherein the further valve member is configured to move in a moving direction that is substantially parallel to the first outlet tube portion and the second outlet tube portion, and the further valve member has at least one contact surface formed thereon facing the further valve seat, and a further biasing member disposed at the second outlet tube portion in the ink outlet path between the further valve member and the interior of the ink storing portion, the further biasing member comprising a first end and a second end opposite the first end, wherein the first end of the further biasing member contacts at least one surface of the further valve member opposite to the contact surface, and the second end of the further biasing member contacts a connection portion of the ink storing portion and the ink outlet tube, wherein the further biasing member is configured to bias the further valve member toward the particular valve and the further valve seat in a biasing direction that is substantially parallel to the moving direction, to close the further valve. The particular valve is disposed between an exterior of the ink cartridge and the further valve.

Other objects, features, and advantages will be apparent to persons of ordinary skill in the art from the following detailed description of the invention and the accompanying drawings.

### BRIEF DESCRIPTION OF THE DRAWINGS

For a more complete understanding of the invention, needs satisfied thereby, and the objects, features, and advantages thereof, reference now is made to the following description taken in connection with the accompanying drawings.

FIG. 1 is a perspective view of an ink jet printer comprising an ink cartridge according to an embodiment of the invention.

FIG. 2 is a schematic side view of the internal structure of the ink jet printer of FIG. 1.

FIG. 3 is a perspective view of an ink cartridge according to an embodiment of the invention.

FIG. 4 is a top view of the internal structure of the ink cartridge of FIG. 3.

FIG. 5A is a partial horizontal cross-sectional view of the ink cartridge of FIG. 3, in which each of a first valve and a second valve is in a closed state, according to an embodiment of the invention.

FIG. 5B is a partial horizontal cross-sectional view of the ink cartridge of FIG. 3, in which each of the first valve and the second valve is in an open state, according to an embodiment of the invention.

FIG. 6A is a partial horizontal cross-sectional views of a mounting portion and top views of the ink cartridge of FIG. 3, in which the ink cartridge is not yet mounted in the mounting portion, according to an embodiment of the invention.

FIG. 6B is a partial horizontal cross-sectional views of a mounting portion and top views of the ink cartridge of FIG. 3, in which the ink cartridge is mounted in the mounting portion according to an embodiment of the invention.

FIGS. 7A-7E are schematic diagrams illustrating timings at which the first and second valves transition to the open and closed states, according to an embodiment of the invention.

FIGS. 8A and 8B are schematic diagrams illustrating timings at which first and second valves transition to the open and closed states in an ink cartridge, according to another embodiment of the invention.

FIG. 9A is a partial horizontal cross-sectional view of an ink cartridge in which each of a first valve and a second valve is in a closed state, according to yet another embodiment of the invention.

FIG. 9B is a partial horizontal cross-sectional view of an ink cartridge in which each of a first valve and a second valve is in an open state, according to yet another embodiment of the invention.

FIG. 10A is a partial horizontal cross-sectional view of an ink cartridge in which each of a first valve and a second valve is in a closed state, according to still yet another embodiment of the invention.

FIG. 10B is a partial horizontal cross-sectional view of an ink cartridge in which each of a first valve and a second valve is in an open state, according to still another embodiment of the invention.

FIG. 11A is a partial horizontal cross-sectional view of an ink cartridge in which each of a first valve and a second valve is in a closed state according to still yet another embodiment of the invention.

FIG. 11B is a partial horizontal cross-sectional view of an ink cartridge in which each of a first valve and a second valve is in an open state according to still yet another embodiment of the invention.

FIG. 12 is a perspective view of an ink cartridge according to a further embodiment of the invention.

FIG. 13 is a top view of the internal structure of the ink cartridge of FIG. 12.

FIG. 14 is a partial horizontal cross-sectional view of the ink cartridge of FIG. 12.

FIG. 15 is a perspective view of a second valve of the ink cartridge of FIG. 12.

FIG. 16A is a vertical cross-sectional view of the second valve of FIG. 15 and an actuator, in which a path in an ink outlet tube is opened, according to a further embodiment of the invention.

FIG. 16B is a vertical cross-sectional view of the second valve of FIG. 15 and an actuator, in which a path in an ink outlet tube is closed, according to a further embodiment of the invention.

FIG. 17A is a partial horizontal cross-sectional view of a mounting portion and top views of the ink cartridge of FIG. 12, in which the ink cartridge is not yet mounted in the mounting portion, according to a further embodiment of the invention.

FIG. 17B is a partial horizontal cross-sectional view of a mounting portion and top views of the ink cartridge of FIG. 12, in which the ink cartridge is mounted in the mounting portion, according to a further embodiment of the invention.

FIG. 18 is a perspective view of an ink cartridge according to yet a further embodiment of the invention.

FIG. 19 is a top view of the internal structure of the ink cartridge of FIG. 18.

FIG. 20 is a partial horizontal cross-sectional view of the ink cartridge of FIG. 18.

FIG. 21A is a partial horizontal cross-sectional view of the ink cartridge of FIG. 18, in which a first valve is in an open state and a second valve is in a closed state, according to yet a further embodiment of the invention.

FIG. 21B is a partial horizontal cross-sectional view of the ink cartridge of FIG. 18, in which and each the first valve and the second valve is in an open state, according to yet a further embodiment of the invention.

### DETAILED DESCRIPTION OF EMBODIMENTS OF THE INVENTION

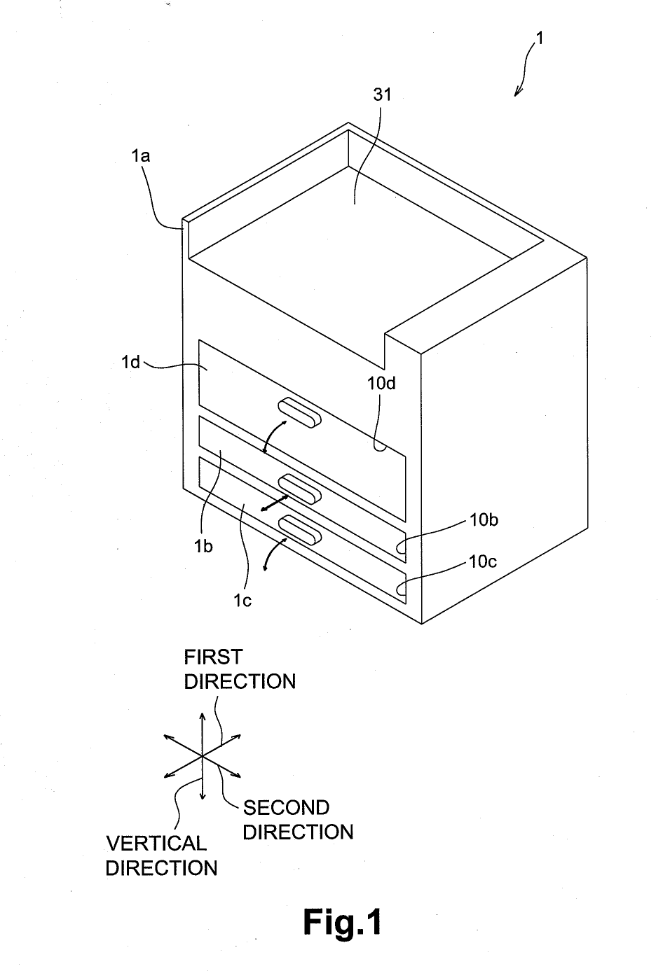

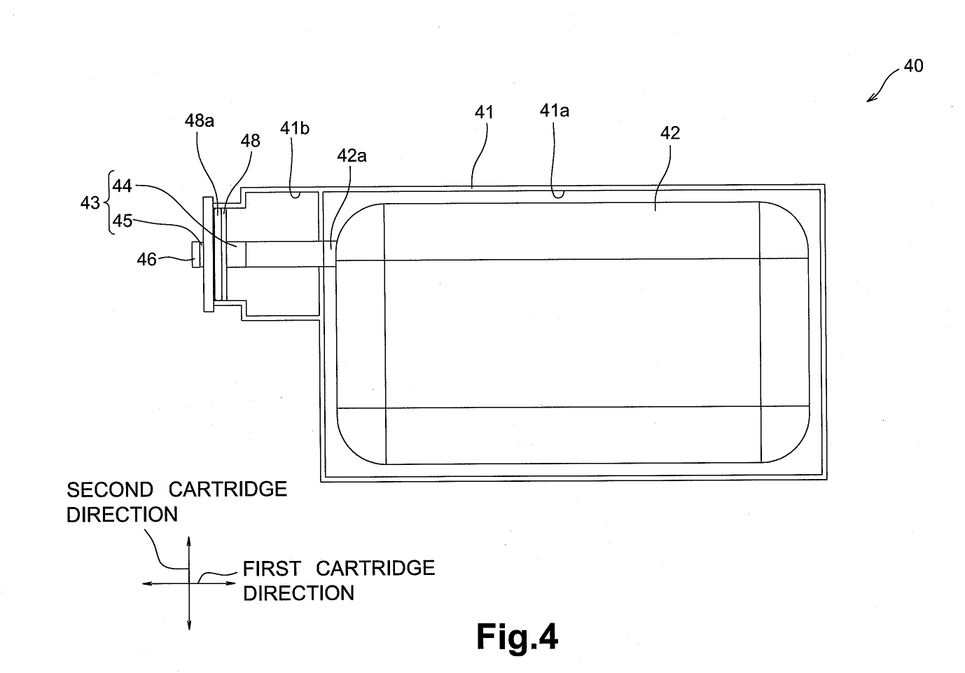

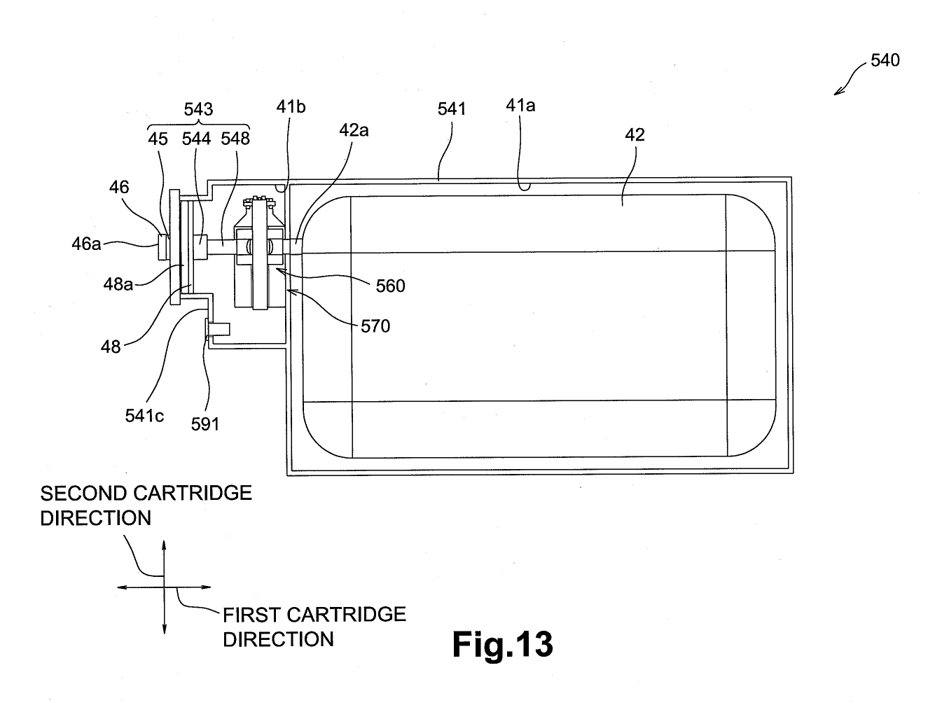

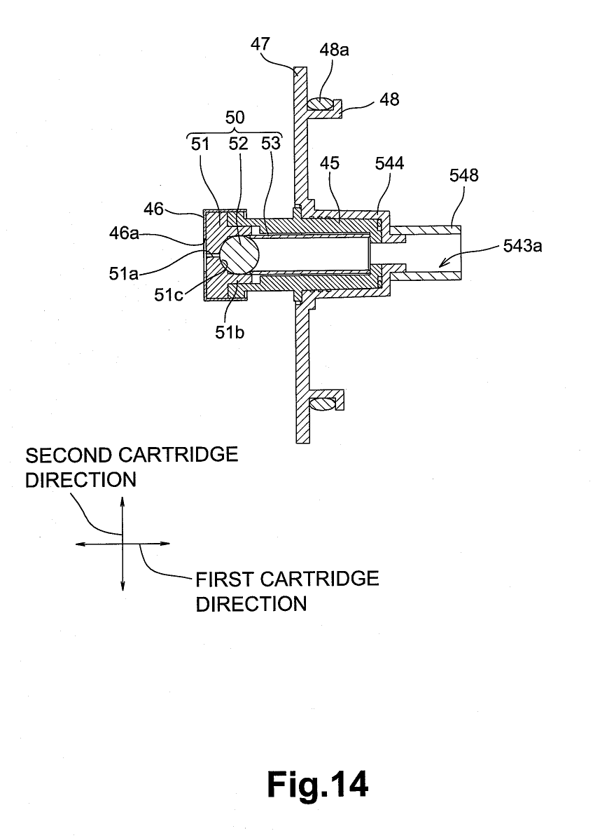

Embodiments of the invention, and their features and advantages, may be understood by referring to FIGS. 1-21B, like numerals being used for like corresponding parts in the various drawings.

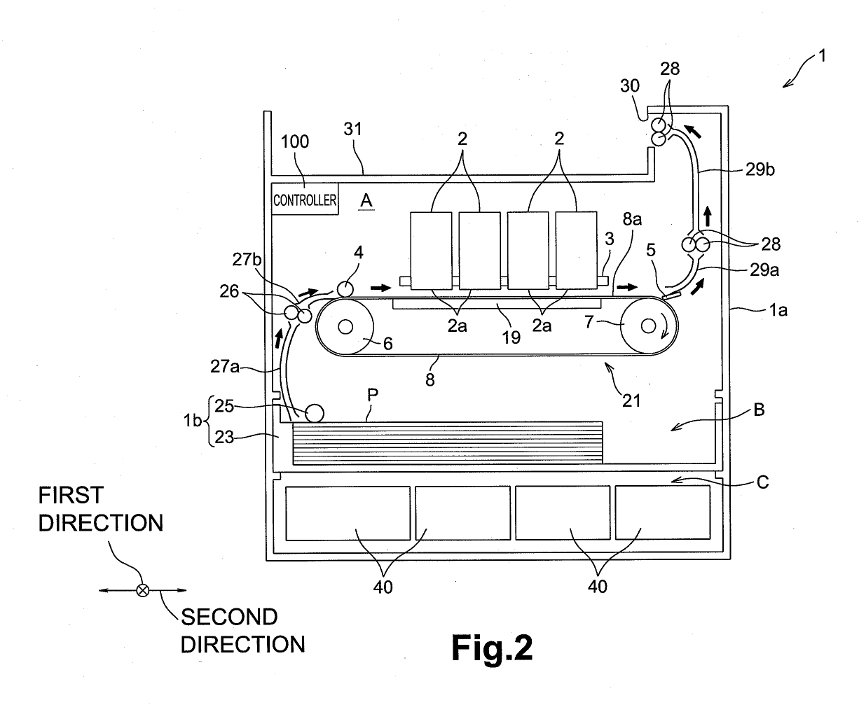

Referring to FIG. 1, in an embodiment of the invention, an ink jet printer 1 may comprise at least one ink cartridge 40. The ink jet printer 1 may comprise a housing 1a having substantially a rectangular parallelepiped shape. The housing 1a may have three openings 10d, 10b, and 10c formed in one of its vertically extending outer faces. The openings 10d, 10b, and 10c may be substantially vertically aligned in this order from above. The ink jet printer 1 further may comprise doors 1d and 1c fitted into the openings 10d and 10c, respectively. Each of the doors 1d and 1c may be configured to pivot about a horizontal axis at its lower end. When the doors 1d and 1c are pivoted to be opened and closed, the openings 10d and 10c are covered and uncovered, respectively. The ink jet printer 1 may comprise a sheet feed unit 1b inserted into the opening 10b. A sheet discharge portion 31 may be disposed at the top of the housing 1a. As shown in FIG. 2, the door 1d may be disposed such that door 1d faces a transporting unit 21 in a first direction, e.g., a primary direction.

Referring to FIG. 2, the interior of the housing 1a of the ink jet printer 1 may be divided into three spaces A, B, and C in the vertical direction, ordered in the listed order when viewed from above. A plurality of, e.g., four, ink jet heads 2 and the transporting unit 21 may be disposed in the space A, and the four ink jet heads 2 may be configured to discharge inks of magenta, cyan, yellow, and black, respectively. The sheet feed unit 1b may be disposed in the space B. A plurality of, e.g., four ink cartridges 40 may be disposed in the space C.

The sheet feed unit 1b and four ink cartridges 40 may be configured to be mounted to and removed from the housing 1a in the first direction. In an embodiment, the transporting unit 21 may transport sheets in a direction parallel with a second direction which is perpendicular to the first direction. Each of the first direction and the second direction is a substantially horizontal direction relative to the orientation of the ink jet printer 1. The ink jet printer 1 may comprise a controller 100 configured to control the sheet feed unit 1b, transporting unit 21, and ink jet heads 2.

A sheet transport path along which sheets P are transported is formed in the ink jet printer 1. The sheet transport path may extend from the sheet feed unit 1b toward the sheet discharge portion 31, as shown by the bold arrows in FIG. 2. The sheet feed unit 1b may comprise a sheet feed tray 23 and a sheet feed roller 25 attached to the sheet feed tray 23 configured to store multiple sheets P. Controller 100 may control a sheet feed motor (not shown) to drive the sheet feed roller 25, which may be configured to feed out the topmost sheet P in the sheet feed tray 23. The sheet P fed out from the sheet feed roller 25 may be nipped by a feed roller pair 26, and may be sent to the transporting unit 21 while being guided by guides 27a and 27b.

Referring to FIG. 2, the transporting unit 21 may comprise two belt rollers 6 and 7, and an endless transport belt 8 wound around the belt rollers 6 and 7. The belt roller 7 may be a driving roller configured to rotate in the clockwise direction, when oriented as shown in FIG. 2, when a shaft thereof is driven by a transport motor (not shown) controlled by the controller 100. The belt roller 6 may be a driven roller configured to rotate in the clockwise direction, when oriented as shown in FIG. 2, due to the force applied from operation of the transport belt 8 caused by the rotation of the belt roller 7.

An outer surface 8a of the transport belt 8 may be subjected to silicone processing, so that the outer surface 8a may have adhesive properties. A nip roller 4 may be disposed above the belt roller 6, sandwiching the transport belt 8 therebetween on the sheet transport path. The nip roller 4 may be configured to press the sheet P fed out from the sheet feed unit 1b against the outer surface 8a of the transport belt 8. The sheet pressed against the outer surface 8a may be held on the outer surface 8a by the adhesive properties thereof, and may be transported toward the right side, when ink jet printer 1 is disposed as shown in FIG. 2.

A separating plate 5 may be disposed above the belt roller 7, with the transport belt 8 disposed between separating plate 5 and the belt roller 7 on the sheet transport path. The separating plate 5 may be configured to separate the sheet P, which is held on the outer surface 8a of the transport belt 8, from the outer surface 8a. After the sheet P has been separated, the sheet P may be transported by being guided by guides 29a and 29b and nipped by two feed roller pairs 28. Then, sheet P may be discharged to the discharge portion 31 from an opening 30 formed through the housing 1a. One roller of each feed roller pair 28 may be driven by a feed motor (not shown) controlled by the controller 100.

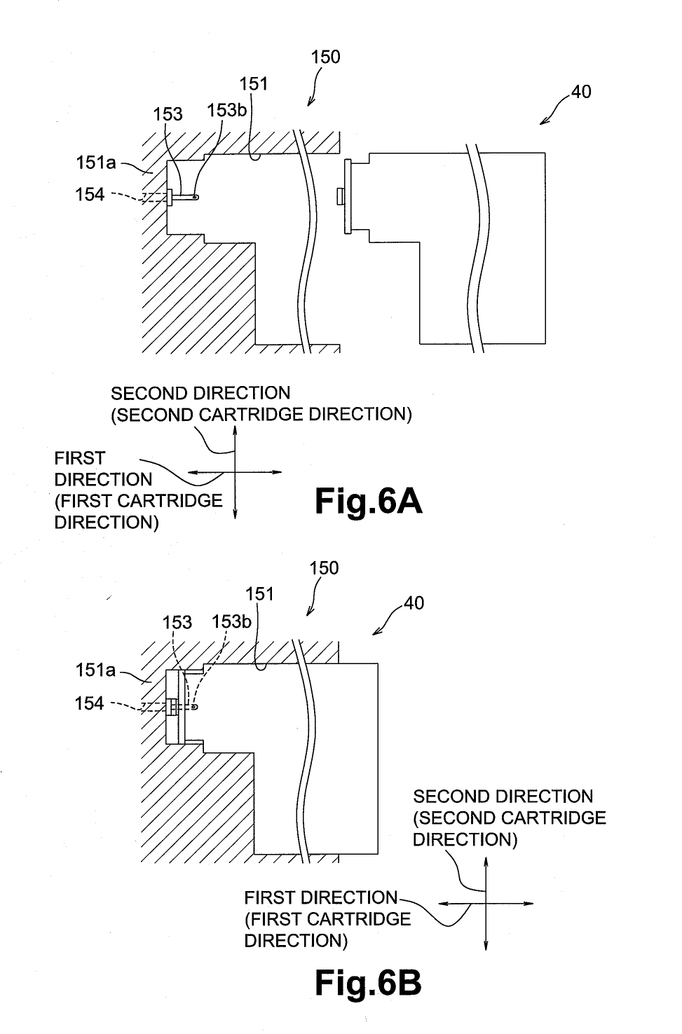

Each of the four ink jet heads 2 may extend in the first direction, and the four ink jet heads 2 may be arrayed in the second direction. The four ink jet heads 3 may be supported by the housing 1a by way of a frame 3. The dimension of each ink jet head 2 in the first direction may be greater than the dimension of the sheet P in the first direction. In an embodiment of the invention, the ink jet printer 1 may be a so-called line printer. The bottom surface of each ink jet head 2 may have a discharge surface 2a, where multiple discharge nozzles (not shown) for discharging ink may be formed. Each ink jet head 2 may be connected with a flexible tube (not shown), such that the interior of the ink jet head 2 may be in fluid communication with the inner path of the flexible tube. Referring to FIGS. 6A and 6B, each flexible tube may be connected to a mounting portion 150, such that the inner path of the flexible tube may be in fluid communication with an ink supply path 154 formed in the mounting portion 150.

A platen 19 may have substantially a rectangular parallelepiped shape, and may be is disposed within the loop of the transport belt 8. The platen 19 may overlap with the four ink jet heads 2 in the vertical direction. The upper surface of the platen 19 may be in contact with the inner surface of the transport belt 8 at an upper portion of the loop of the transport belt 8, and the platen 19 may support the transport belt 8 from the interior of transport belt 8. Accordingly, the outer surface 8a of the transport belt 8 at the upper portion of the loop thereof may face the discharge surfaces 2a of the ink jet heads 2, and may extend in parallel with the discharge surfaces 2a. A slight gap may be formed between the discharge surfaces 2a and the outer surface 8a, and the sheet transport path may extend through this gap. When the sheet P held on the outer surface 8a of the transport belt 8 passes immediately below the four ink jet heads 2, ink of each color may be discharged toward the upper surface of the sheet P from a corresponding one of the ink jet heads 2 under control of the controller 100, thereby forming a desired color image on the sheet P.

Of the four ink cartridges 40, the ink cartridge 40 at the leftmost position in FIG. 2 may store black ink. In an embodiment of the invention, the ink cartridge 40 storing black ink may have a greater size, as compared to the other three ink cartridges 40. Specifically, in an embodiment of the invention, the ink cartridge 40 that stores black ink may extend further in the second direction than the other ink cartridges 40. The ink cartridge 40 at the leftmost position may have a greater ink capacity than the other three ink cartridges 40. The other three ink cartridges 40 may have substantially the same ink capacity, and may store magenta, cyan, and yellow inks, respectively. When the four ink cartridges 40 are mounted in the housing 1a, the interior of an ink bag 42 (described later) of each ink cartridge 40 may be placed in fluid communication with the ink supply path 154, which may be in fluid communication with the interior of a corresponding one of the ink jet heads 2. Thus, ink stored in the ink bag 42 may be supplied to the ink jet head 2 via ink supply path 154.

When the ink cartridge 40 is intended to be replaced, the door 1c may be opened and the ink cartridge 40 may be removed from the housing 1a via the opening 10. A new ink cartridge 40 may be mounted in to the housing 1a via the opening 10c. In an embodiment, the ink cartridges 40 are configured to be individually mounted into the housing 1a, but in another embodiment, the four ink cartridges 40 may be loaded on a single cartridge tray to form an integral unit, and the unit may be mounted into the housing 1a.

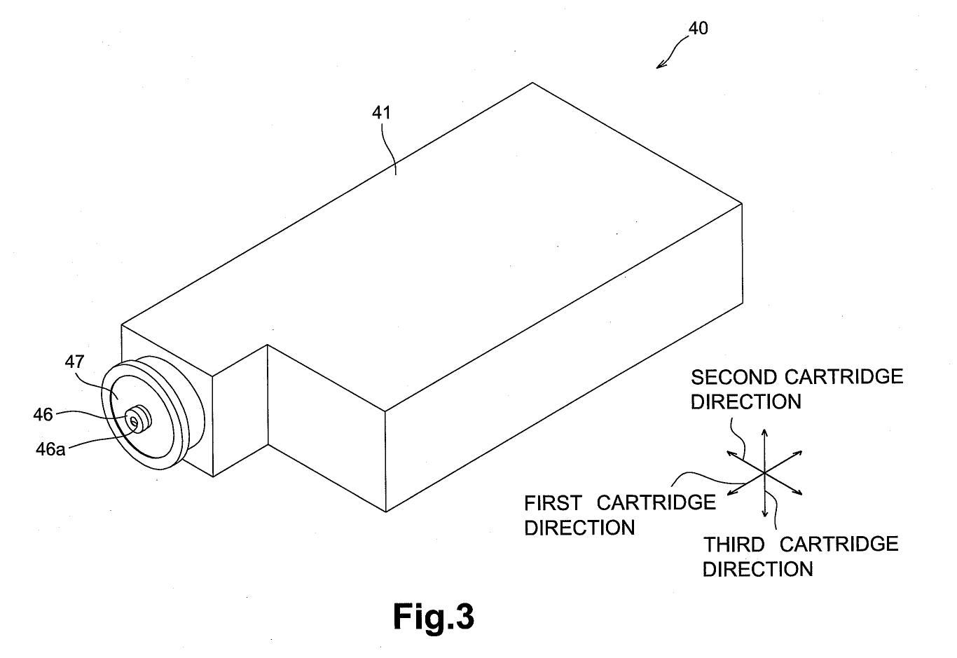

Referring to FIGS. 3 to 5B, an ink cartridge 40 may comprise a housing 41 having substantially a rectangular parallelepiped shape, an ink bag 42, e.g., an ink storing portion, which may be disposed within the housing 41, an ink outlet tube 43, which may be connected to the ink bag 42 at one end, a first valve 50, and a second valve 60. The ink bag 42 may be configured to store ink therein.

The dimension of the housing 41a in a first cartridge direction, i.e., the length, may be greater than the dimension of the housing 41 in a second cartridge direction, i.e., the width, and the width of the housing 41 in the second cartridge direction is greater than the dimension of the housing in a third cartridge direction, i.e., the height. The first cartridge direction, the second cartridge direction, and the third cartridge direction are substantially perpendicular to each other. When the ink cartridge 40 is mounted in the mounting portion 150, the first cartridge direction is aligned with the first direction, the second cartridge direction is aligned with the second direction, and the third cartridge direction is aligned with the vertical direction.

The interior of the housing 41 may be divided into two chambers 41a and 41b in the first direction. The ink bag 42 may be disposed in the chamber 41a, which may be larger than the chamber 41b. The ink outlet tube 43 may be disposed in the chamber 41b. As described above, the ink cartridge 40 for storing black ink is greater in size and ink capacity than the other three ink cartridges 40. Nevertheless, in an embodiment of the invention, the difference between the ink cartridge 40 for storing black ink and the ink cartridges 40 for storing other types of ink is that the chamber 41a and ink bag 42 of the ink cartridge 40 for storing black ink are merely greater than those of the other three ink cartridges 40 in the second direction. Thus, in an embodiment, the four ink cartridges 40 have almost the same structure. Accordingly, detailed operation of only one ink cartridge 40 will be described herein.

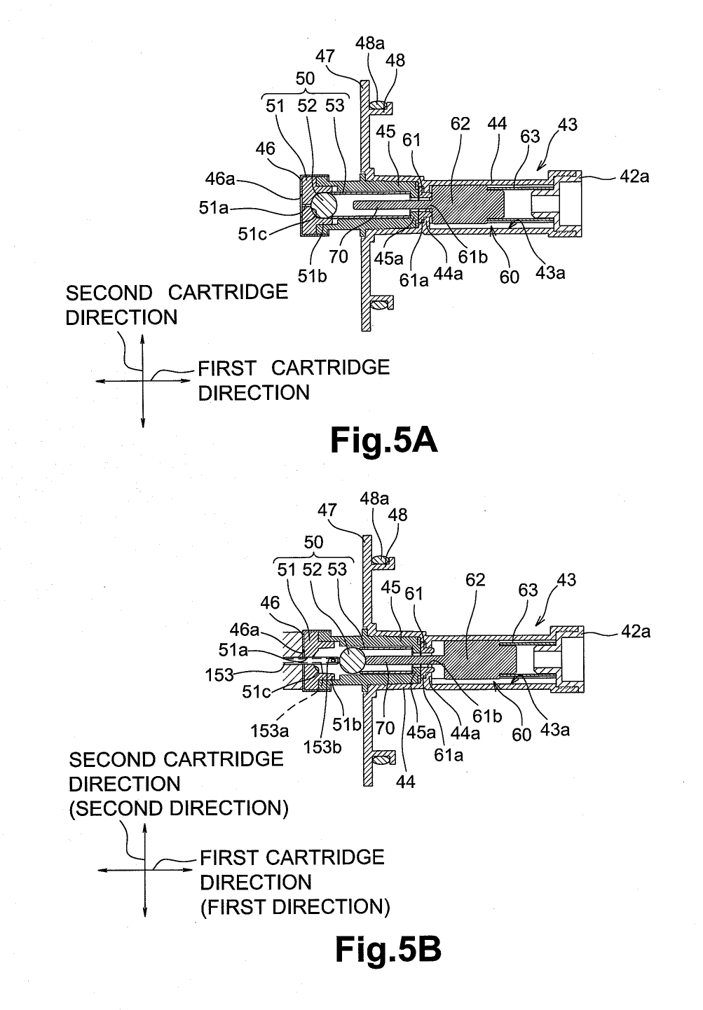

The ink bag 42 may be connected to a connecting portion 42a, such that ink stored in the ink bag 42 may be supplied to the outside of the ink bag 42 through the connecting portion 42. The ink outlet tube 43 may have has a tube 44, e.g., a cylindrical tube 44, connected to a connecting portion 42a at a first end thereof, and a tube 45, e.g., a cylindrical tube 45, fitted into a second end, e.g., the left end, when positioned as shown in FIGS. 5A and 5B, of the tube 44. The ink outlet tube 43 may have an ink outlet path 43a formed therein. More specifically, a first end of the tube 45 may be fitted into the tube 44, but a second end of the tube 45 may be positioned outside of the tube 44. The ink outlet tube 43, i.e., the tubes 44 and 45, may extend in the first direction. Accordingly, the ink outlet path 43a defined by the ink outlet tube 43 also may extend in the first direction. The ink outlet path 43a may be configured to be in fluid communication with the interior of the ink bag 42 via the connecting portion 42a at a first end thereof, and to be in fluid communication with the outside of the ink cartridge 40 at a second end thereof.

A ring-shaped flange 47 may be provided at the second end of the tube 44 opposite the first end of the tube 44 connected to the connecting portion 42a. The flange 47 may extend from an outer surface of the second end of the tube 44 in radial directions of the tube 44. A ring-shaped protrusion 48 may extend from the flange 47 toward the ink bag 42 in the first direction. An O-ring 48a may be fitted around the protrusion 48. The flange 47 may form at least a portion of one of walls defining the chamber 41b, and also may define is a portion of the housing 41. Another portion of the housing 41 is connected to the flange 47, such that the O-ring 48a is positioned between flange 47a and protrusion 48. Therefore, O-ring 48a may reduce the likelihood that ink may leak around the flange 47.

The first valve 50 may be disposed at the ink outlet path 43a defined by the tube 45 of the ink outlet tube 43. The first valve 50 may comprise a sealing member 51 which is an elastic member positioned in the ink outlet path 43a and contacting the inner surface of the tube 45 to close an opening of the ink outlet path 43a formed at the second end of the ink outlet path 43a. The first valve 50 may comprise a spherical member 52, as a first valve member, which may be disposed in the ink outlet path 43a, and a coil spring 53, as a first biasing member, which may be disposed in the ink outlet path 43a. A lid 46 may be attached to the second end of the tube 45, such that the sealing member 51 may maintain an attachment to the tube 45. An ink discharge opening 46a may be formed through the lid 46.

The coil spring 53 may extend in the first direction, and one end of the coil spring 53 may be in contact with the spherical member 52. The other end of the coil spring 53 may be in contact with a platform portion 45a, which may be located at the first end of the tube 45. The coil spring 53 may be configured to apply a constant biasing force to bias the spherical member 52 toward the sealing member 51. In an embodiment, the coil spring 53 is used as a biasing member. Nevertheless, in other embodiments, any suitable biasing member which can bias the spherical member 52 toward the sealing member 51 may be used.

The sealing member 51 may comprise an elastic material, such as rubber or the like. The sealing member 51 may have an opening 51a formed therethrough, and the opening 51a may extend in the first direction at the middle of the sealing member 51. The sealing member 51 may comprise a ring-shaped protrusion 51b fitted into the second end of the tube 45, such that ring-shaped protrusion 51b may contact the inner surface of the tube 45. The sealing member 51 also may comprise a curved portion 51c facing the spherical member 52 and having a shape following the outer circumferential surface of the spherical member 52. The curved portion 51c may be surrounded by the ring-shaped protrusion 51b. The diameter of the opening 51a may be less than the outer diameter of a hollow tube 153 (described in more detail herein). When the hollow tube 153 is inserted into the opening 51a, the sealing member 51 may contact the outer surface of the hollow tube 153 while being elastically deformed. Therefore, ink leakage from between the sealing member 51 and the hollow tube 153 may be prevented.

The inner diameter of the ring-shaped protrusion 51b may be slightly less than the diameter of the spherical member 52. The fluid communication between the ink outlet path 43a and the outside of the ink cartridge 40 via the opening 51a may be prevented when the spherical member 52 contacts the ring-shaped protrusion 51b. The fluid communication between the ink outlet path 43a and the outside of the ink cartridge 40 via the opening 51a also may be prevented when the spherical member 52 contacts the curved portion 51c. In other words, the first valve 50 may be configured to prevent ink in the ink outlet path 43a from flowing via the first valve 50 when the spherical member 52 contacts the ring-shaped protrusion 51b and/or the curved portion 51c.

Referring to FIG. 5B, when the hollow tube 153 is inserted into the opening 51a via the ink discharge opening 46a, the tip of the hollow tube 153 may come into contact with the spherical member 52, and the spherical member 52 may move, thereby separating spherical member from the curved portion 51c and the ring-shaped protrusion 51b. When this occurs, the state of the first valve 50 may change from a closed state, in which the first valve 50 prevents ink in the ink outlet path 43a from flowing via the first valve 50, to an open state, in which the first valve 50 allows ink in the ink outlet path 43a to flow via the first valve 50.

The hollow tube 153 may have an opening 153b formed therethrough, and the inner space 153a of the hollow tube 153 may be in fluid communication with the outside of the hollow tube 153 via the opening 153b. When the first valve 50 is in the open state, the opening 153b of the hollow tube 153 has passed through the opening 51a. Thus, in the open state, the inner space 153a of the hollow tube 153 and the ink outlet path 43a may be in fluid communication via the opening 153b. When the hollow tube 153 is moved to be removed from the opening 51a, i.e., away from spherical member 52, the spherical member 52 may move toward the ring-shaped protrusion 51b due to the biasing force of the coil spring 53. When the spherical member 52 comes into contact with the ring-shaped protrusion 51b, the state of the first valve 50 changes from the open state to the closed state.

When the hollow tube 153 further moves out of the opening 51a, the spherical member 52 comes into close contact with the curved portion 51c. Accordingly, the first valve 50 is configured to selectively be in the open state and the closed state in accordance with insertion and removal of the hollow tube 153. Because the coil spring 53 is part of valve 50, and coil spring 53 biases the spherical member 52 toward the sealing member 51, and the structure of the first valve 50 is simplified and leakage of ink from the first valve 50 may be reduced or prevented.

Referring to FIGS. 5A and 5B, the second valve 60 may be disposed at the ink outlet path 43a between the ink bag 42 and the first valve 50. The second valve 60 may comprise a valve seat 61, a valve member 62, e.g., a second valve member, and a coil spring 63, e.g., a second biasing member, disposed in the ink outlet path 43a. The tube 44 may comprise a ring-shaped protrusion 44a protruding from the inner surface of the tube 44 into the ink outlet path 43a at a middle portion of the tube 44 in the first direction. The valve seat 61 may comprise an elastic material such as rubber or the like, and may comprise a flange 61a sandwiched between the ring-shaped protrusion 44a of the tube 44 and the platform portion 45a of the tube 45. In another embodiment of the invention, valve seat 61, may comprise a completely inelastic material. In still another embodiment of the invention, valve seat 61 may be omitted, and tube 44 may comprise a completely inelastic material. In such an embodiment, the valve member 62 may be configured to prevent ink in the ink outlet path 43a from flowing through the second valve 60 when the valve member 62 contacts the ring-shaped protrusion 44a of the tube 44. The valve seat 61 may have an opening 61b formed therethrough, and the opening 61b may extend in the first direction at the middle of the valve seat 61, such that the interior of the tube 44 and the interior of the tube 45 may be in fluid communication with each other, and may form the ink outlet path 43a. In the illustrated embodiments, a cross-section of the valve seat 61 may have substantially a L-shape. Nevertheless, in another embodiment of the invention, the cross-section of the valve seat 61 may have other shapes. In addition, in the illustrated embodiments, valve seat 61 may be formed within wall 44. Nevertheless, in another embodiment, valve seat 61 may be integrally formed with one or both of wall 44 and wall 45. The valve member 62 and the coil spring 63 each may be disposed in the ink outlet path 43a defined by the tube 44.

One end of the coil spring 63 may be in contact with the valve member 62 and the other end of the coil spring 63 may be in contact with the connecting portion 42a. The coil spring 63 is configured to constantly bias the valve member 62 toward the valve seat 61 and the sealing member 51, such that the portion of the valve seat 61 is elastically deformed by the biasing force of the coil spring 63. The valve member 62 may be configured to prevent ink in the ink outlet path 43a from flowing through the second valve 60 when the valve member 62 contacts a portion of the valve seat 61 surrounding the opening 61b. A position at which valve member 62 contacts valve seat 61 may define a boundary between a first path portion, which may extend from an exterior of the ink cartridge 40 to the boundary, and a second path portion, which may extend from the boundary to an interior of the ink bag 42. When this occurs, the valve member 62 is in a closed state, and fluid communication between the interior of the tube 44 and the interior of the tube 45 is prevented. Because the coil spring 63 is configured to bias the valve member 62 toward the sealing member 51, and because the first and second valves 50 and 60, i.e., the sealing member 51, the spherical member 52, the coil spring 53, the valve seat 61, the valve member 62, and the coil spring 63, are aligned on a single straight line in the first direction, the first and second valves 50 and 60 may be opened and closed when the hollow tube 153 is inserted into and removed from the sealing member 51 in the first direction. In an embodiment of the invention, the second valve 60 may have a simple structure, which may reduce a likelihood of opening or closing failure of the second valve 60. In an embodiment, the coil spring 63 is used as a biasing member, but in other embodiments, any a biasing member that biases the valve member 62 toward the valve seat 61 may be used.

The valve member 62 may have a substantially cylindrical shape, and may be configured to slide on the inner surface of the tube 44. A first end of the valve member 62 facing the connecting portion 42a may have a protruding shape that protrudes at the middle of valve member 62 in the first direction. The coil spring 63 may be fitted around the protruding portion of the valve member 62. The valve member 62 may have a width in a direction perpendicular to the first cartridge direction. The width of valve member 62 may be greater than an interior width of at least a portion of tube 45, e.g., as shown in FIGS. 5A and 5B. Moreover, the width of valve member 62 may be less than an interior width of tube 44, so that ink may flow through tube 44 when the valve member 62 is separated from the valve seat 61. The width of valve member 62 may be defined as the average width. In another embodiment of the invention, the width of the valve member 62 may be defined as the width of the portion that contacts the valve seat. Moreover, the second width of the second path portion is defined as the average width, but in another embodiment, the second width of the second path portion is defined at the boundary between the first path portion and the second path portion. A pressing member 70 may be disposed in the ink outlet tube 43. Pressing member 70 may be configured to press and move the valve member 62 in a direction opposite to a direction in which the coil spring 63 biases the valve member 62. The pressing member 70 may be a cylindrical rod extending in the first direction through the opening 61b of the valve seat 61. The pressing member 70 may be connected to a second end of the valve member 62 and, in an embodiment of the invention, may be integrally formed with the valve member 62. The pressing member 70 may have a diameter less than the diameter of the opening 61b. The pressing member 70 may have such a length that a gap is formed between the tip of the pressing member 70 and the spherical member 52 when the state of the first valve 50 changes from the open state to the closed state, e.g., when the spherical member 52 moves toward the sealing member 51 to contact the ring-shaped protrusion 51b, while the second valve 60 is in the closed state, e.g., the valve member 62 contacts the valve seat 61.

Referring to FIG. 5B, after the hollow tube 153 is inserted through the sealing member 51 and the first valve 50 transitions into the open state, the spherical member 52 may come into contact with the tip of the pressing member 70. When the hollow tube 153 is further inserted, the pressing member 70 and valve member 62 may move, and the valve member 62 may moves away from the valve seat 61. Accordingly, the state of the second valve 60 transitions from the closed state to an open state. In the open state, the second valve 60 may allow ink in the ink outlet path 43a to flow via the second valve 60. When this occurs, the interior of the tube 44 and the interior of the tube 45 of the ink outlet path 43a may be brought into fluid communication, such that ink stored in the ink bag 42 may flow into the inner space 153a of the hollow tube 153.

Similarly, when the hollow tube 153 is removed from the sealing member 51, the valve member 62 and pressing member 70 may move, due to the biasing of the coil spring 63 toward the valve seat 61, and the valve member 62 may contact the valve seat 61. Accordingly, the state of the second valve 60 may transition from the open state to the closed state. Thus, the second valve 60 also may be configured to selectively be in the open state, in which the second valve 60 allows ink in the ink outlet path 43a to flow via the second valve 60, and the closed state, in which the second valve 60 prevents ink in the ink outlet path 43a from flowing via the second valve 60.

Referring to FIGS. 6A and 6B, the ink jet printer 1 may comprise a plurality of, e.g., four, mounting portions 150 arrayed in the second direction, to which the four ink cartridges 40 may be mounted, respectively. Each of the four mounting cartridges 150 has substantially the same structure. Accordingly, only one mounting portion 150 is described herein. The mounting portion 150 may have a recess 151 formed therein. The recess 151 may have a shape corresponding to the outer shape of the ink cartridge 40. The hollow tube 153 may be disposed at a base portion 151a defining an end of the recess 151 in the second direction. The ink supply path 154 may be formed in the base portion 151a and may be in fluid communication with the inner path of the flexible tube connected to the ink jet head 2.

The hollow tube 153 may extend in the first direction, and may be disposed at a position corresponding to the opening 51a when the ink cartridge 40 is mounted to the mounting portion 150. The hollow tube 153 has the inner space 153a formed therein, which may be in fluid communication with the ink supply path 154, and also has the opening 153b formed therethrough near the tip thereof to allow the inner space 153a to be in fluid communication with the outside of the hollow tube 53, as shown in FIGS. 5A and 5B. When the ink cartridge 40 is mounted to mounting portion 150 and the hollow tube 153 is inserted into the sealing member 51, such that the opening 153b enters the ink outlet path 43a defined by the tube 45 past the opening 51a, the inner space 153a of the hollow tube 153 and the ink outlet path 43a may be placed into fluid communication via the opening 153b. Similarly, when the ink cartridge 40 is removed from the mounting portion 150 and the hollow tube 153 is removed from the sealing member 51, such that the opening 153b enters the opening 51a, the path between the inner space 153a of the hollow tube 153 and the ink outlet path 43a is blocked, and there is no fluid communication between inner space 153a and ink outlet path 43a. Even if the inner space 153a of the hollow tube 153 is in fluid communication with the ink outlet path 43a via the opening 153b, either by first valve 50 being in the open state, or by a malfunction of first valve 50, ink stored in ink bag 42 may not flow into the inner space 153a until the second valve 60 transitions to the open state.

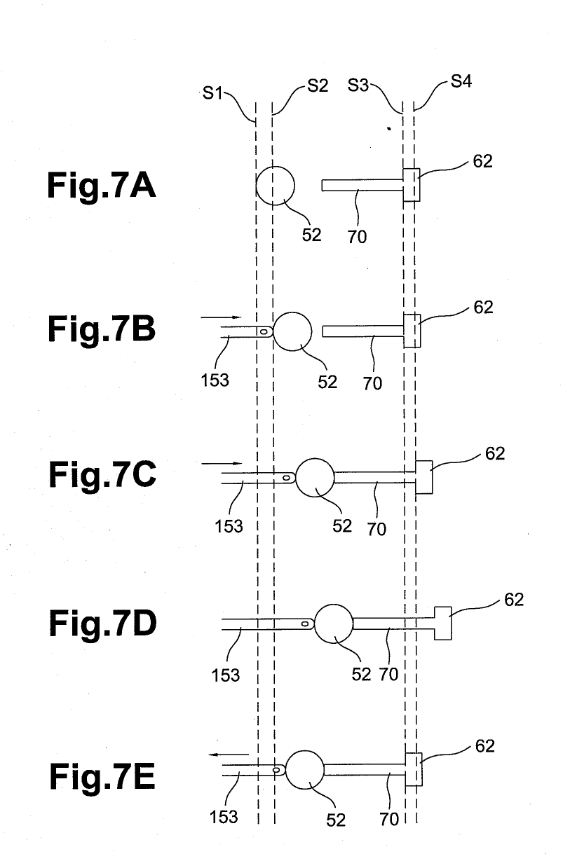

FIGS. 7A-7D show how the first valve 50 and the second valve 60 operate during the mounting of the ink cartridge 40 to the mounting portion 150, according to an embodiment of the invention, and FIG. 7E illustrates how the first valve 50 and the second valve 60 operate during the removal of the ink cartridge 40 from the mounting portion 150. The dotted line S1 shown in FIGS. 7A-7E represents a boundary line indicating a boundary between an end of the spherical member 52, which end is most distant from the second valve 60 in the first direction, e.g., the left end of the spherical member 52 when arranged as shown in FIGS. 7A-7E, and the curved portion 51c, when the spherical member 52 and the curved portion 51c are in contact. The dotted line S2 represents a boundary line at which the state of the first valve 50 transitions between the open state and the closed state when the spherical member 52 moves. The dotted line S3 represents a boundary line indicating the boundary between the valve seat 61 and the valve member 62 when the valve seat 61 is in contact with the valve member 62 while being elastically deformed, and the pressing member 70 is not in contact with the spherical member 52. The dotted line S4 represents a boundary line at which the state of the second valve 60 transitions between the open state and the closed state when the valve member 62 moves.

Referring to FIG. 7A, when the hollow tube 153 is not inserted into the ink outlet tube 43, i.e., when the ink cartridge 40 is not mounted to the mounting portion 150, the biasing force of the coil spring 53 may be applied to the spherical member 52, and the end, i.e., the left end when disposed as shown in FIG. 7A, of the spherical member 52 may be positioned on the boundary line S1. In other words, the first valve 50 is in the closed state, and the spherical member 52 may be in contact with the curved portion 51c and the ring-shaped protrusion 51b.

When the mounting of the ink cartridge 40 to the mounting portion 150 is initiated, the door 1c of the ink jet printer 1 may be opened, and the ink cartridge 40 may be mounted to a corresponding one of the mounting portions 150 via the opening 10c. As shown in FIG. 7B, when the hollow tube 153 is inserted into the opening 51a, the tip of the hollow tube 153 may come into contact with the spherical member 52, and the spherical member 52 moves toward the second valve 60, e.g., to the right when disposed as shown in FIGS. 7A-7E.

When the end of the spherical member 52 contacting the hollow tube 1543 crosses the boundary line S2, the spherical member 52 and the sealing member 51 may be separated, and the state of the first valve 50 may transition from the closed state to the open state. Thus, the first valve 50 may transition to the open state when the spherical member 52 moves from a state in which the spherical member 52 contacts the curved portion 51c to more than a distance between the boundary lines S1 and S2. During the period when the end of the spherical member 52 is positioned between the boundary lines S1 and S2, the spherical member 52 may maintain contact with the ring-shaped protrusion 51b, and the first valve 50 may be maintained in the closed state. When the state of the first valve 50 transitions into the open state, there still may be a gap between the spherical member 52 and the pressing member 70. Therefore, in this state, e.g., as shown in FIG. 7B, the first valve 50 is in the open state, and only the biasing force of the coil spring 63 is applied to the valve member 62.

The biasing force of the coil spring 63 is applied to the valve member 62 such that an end of the valve member 62, which end is most distant from the connecting portion 42a in the first direction, e.g., the left end when valve member 62 is disposed as shown in FIGS. 7A-7E, may be positioned on the boundary line S3, and the second valve 60 may be maintained in the closed state. When the second valve 60 is in the closed state, a portion of the valve seat 61 facing the valve member 62, e.g., the right portion of the valve seat 61 when disposed as shown in FIGS. 7A-7E, may be in contact with the valve member 62 while being elastically deformed, i.e., compressed in the biasing direction of coil spring 63, due to the biasing force of the coil spring 63.

Referring to FIG. 7C, when the hollow tube 153 is further inserted, the spherical member 52 may come into contact with the tip of the pressing member 70, and the spherical member 52, pressing member 70, and valve member 62 may move toward the connecting portion 42a, e.g., to the right when disposed as shown in FIGS. 7A-7E. When the end of the valve member 62 that contacts the spherical member 52 crosses the boundary line S4, the valve member 62 and the valve seat 61 may be separated, and the state of the second valve 60 may transition from the closed state to the open state. Thus, the second valve 60 may become the open state when the valve member 62 moves more than a distance between the boundary lines S3 and S4 from the boundary line S3. During the period when the end of the valve member 62 is positioned between the boundary lines S3 and S4, the valve member 62 may maintain contact with the valve seat 61, and the second valve 60 may be maintained in the closed state. The distance between the boundary lines S3 and S4 may correspond to the elastically deformable range of the valve seat 61.

Referring to FIG. 7D, the hollow tube 153 may be further inserted until the mounting of the ink cartridge 40 to the mounting portion 150 is completed, and the hollow tube 153 may stop when the mounting is completed. Thus, the state of each of the first and second valves 50 and 60 may change from the closed state to the open state in accordance with the insertion of the hollow tube 153 into the ink outlet path 43a, such that the second valve 60 transitions from the closed state to the open state after the first valve 50 transitions from the closed state to the open state. Thus, ink stored in the mounted ink cartridge 40 may flow into the inner space 153a of the hollow tube 153, and thereby ink may be supplied from the ink cartridge 40 to the ink jet head 2.

Referring to FIG. 7E, the ink cartridge 40 may be removed from the mounting portion 150, e.g., because all the usable ink from ink cartridge 40 has been dispensed. The spherical member 52, the valve member 62, and the pressing member 70 may move together in a direction away from the connecting portion 42a, e.g., to the left when disposed as shown in FIG. 7E, while contacting each other, due to the biasing forces of the coil springs 53 and 63, in accordance with the movement of the hollow tube 153 being removed from the ink outlet tube 43 as the ink cartridge 40 is removed from the mounting portion 150. In other words, when hollow tube 153 is removed, the spherical member 52, the pressing member 70, and the valve member 62 move in a direction opposite to a direction in which they move when the hollow tube 153 is inserted into the sealing member 51. When the end of the valve member 62 reaches the boundary line S4, the valve member 62 comes into contact with the valve seat 61, and the state of the second valve 60 transitions from the open state to the closed state. When this occurs, the flow of ink from the ink bag 42 to the inner space 153a of the hollow tube 153 stops.

Subsequently, the valve member 62 and pressing member 70 may move until the end of the valve member 62 reaches the boundary line S3. When the end of the valve member 62 reaches the boundary line S3, the motion of the valve member 62 and the pressing member 70 stops, and second valve 60 completes its transition to the closed state. Then, only the spherical member 52 moves along with the hollow tube 153, such that the spherical member 52 and the tip of the pressing member 70 may separate from each other. When the end of the spherical member 52 that contacts hollow tube 153 reaches the boundary line S2, the spherical member 52 and the ring-shaped protrusion 51b come into contact, and the state of the first valve 50 transitions from the open state to the closed state. Subsequently, the spherical member 52 may move until the end of the spherical member 52 reaches the boundary line S1. Thus, the state of each of the first and second valves 50 and 60 may transition from the open state to the closed state in accordance with the movement of the hollow tube 153 as it is removed from the sealing member 51. In an embodiment of the invention, the first valve 50 may transition to the closed state after the second valve 60 transitions to the closed state. In this way, the old ink cartridge 40 may be removed from the mounting portion 150, and a new ink cartridge 40 is mounted to the mounting portion 150. The coil spring 63 may have a modulus of elasticity such that the biasing force applied to the valve member 62 by coil spring 63 may exceed the force generated when shock is applied to the valve member 62, such that no gap will open in the second valve 60 due to a shock, e.g., when a user handles the ink cartridge 40. Also, because the valve member 62 is constantly biased against the valve seat 61 by the coil spring 63, the second valve 60 may be maintained in the closed state when the ink cartridge 40 is not in use, e.g., removed from the mounting portion 150.

As described above, in the ink cartridge 40 according to an embodiment, when the hollow tube 153 is inserted into the sealing member 51, the first valve 50 transitions from the closed state to the open state, and then the hollow tube 153 moves the spherical member 52, the pressing member 70, and the valve member 62, such that the valve member 62 moves away from the valve seat 61, which causes the second valve 60 to transition from the closed state to the open state. When the hollow tube 153 is removed from the sealing member 51, the second valve 60 transitions from the open state to the closed state, and then the first valve 50 transitions from the open state to the closed state. Accordingly, at the instant in which the hollow tube 153 is completely separated from the sealing member 51, the second valve 60 has already completed transitioning to the closed state. Therefore, even if the first valve 50 is damaged prior to or upon removal of hollow tube 153, massive leakage of ink may be reduced when after the hollow tube 153 is removed from the first valve 50 and when the first valve 50 is in the closed state.

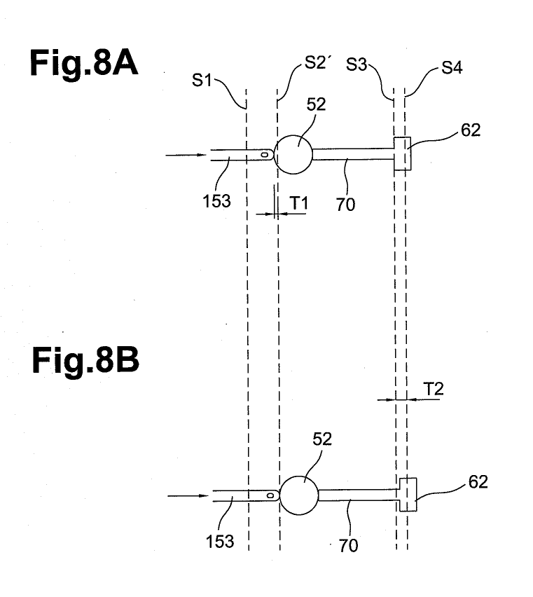

In another embodiment of the invention, e.g., as shown in FIGS. 8A and 8B, the ring-shaped protrusion 51b is wider in the first direction than the ring-shaped protrusion 51b in the embodiment described above. Therefore, although a gap may be formed between the spherical member 52 and the pressing member 70 when the first valve 50 transitions to the open state in the previously described embodiment, the spherical member 52 may contact the pressing member 70 before the first valve 50 transitions to the open state, such that there is no gap formed between the spherical member 52 and pressing member 70 when the first valve 50 transitions to the open state.

Referring to FIGS. 8A and 8B, in this another embodiment, a boundary line S2′ is positioned closer to the boundary line S3 than the boundary line S2 is positioned to the boundary line S3 in the previously-described embodiment. In this case, referring to FIG. 8A, when the hollow tube 153 is inserted into the ink outlet tube 43, and the spherical member 52 comes into contact with the tip of the pressing member 70, the end of the spherical member 52 contacting the hollow tube 153 has not passed over the boundary line S2′, e.g., the first valve 50 may still be maintained in the closed state. The ring-shaped protrusion 51b may have such a length that the first valve 50 transitions to open state after the spherical member 52 comes into contact with the pressing member 70, but before the second valve 60 transitions to the open state. Referring to FIG. 8B, when the end of the spherical member 52 contacting the hollow tube 153 reaches the boundary line S2′, the end of the valve member 62 is positioned between the boundary lines S3 and S4.

A distance T1, may be defined as a distance that the spherical member 52 moves from the time when the spherical member 52 comes into contact with the pressing member 70 up to the time when the first valve 50 transitions to the open state. The distance T1 is less than a distance T2, which may be defined as a distance that the valve member 62 moves from the time when the spherical member 52 comes into contact with the pressing member 70 up to the time when the end of the valve member 62 contacting the hollow tube 153 reaches the boundary line S4. Accordingly, in this another embodiment, during the mounting of the ink cartridge 40 to the mounting portion 150, the second valve 60 transitions to the open state after the first valve 50 has transitioned to the open state. Similarly, during the removal of the ink cartridge 40 from the mounting portion 150, the first valve 50 transitions to the closed state after the second valve 60 transitions to the closed state. Accordingly, the same advantages as with the first embodiment can be obtained.

In the above-described embodiment, the ring-shaped protrusion 51b extends further in the first direction than in the first described embodiment. In yet another embodiment, the pressing member is made to be longer in the first direction than in the first described embodiment, instead of the ring-shaped protrusion 51b being longer in the first direction. In this embodiment, the pressing member may have a sufficient length such that a distance the spherical member 52 moves from the time when the spherical member 52 comes into contact with the pressing member up to the time when the first valve 50 transitions to the open state, is less than a distance the valve member 62 moves from the time when the spherical member 52 comes into contact with the pressing member up to the time when the second valve 60 transitions to the open state.

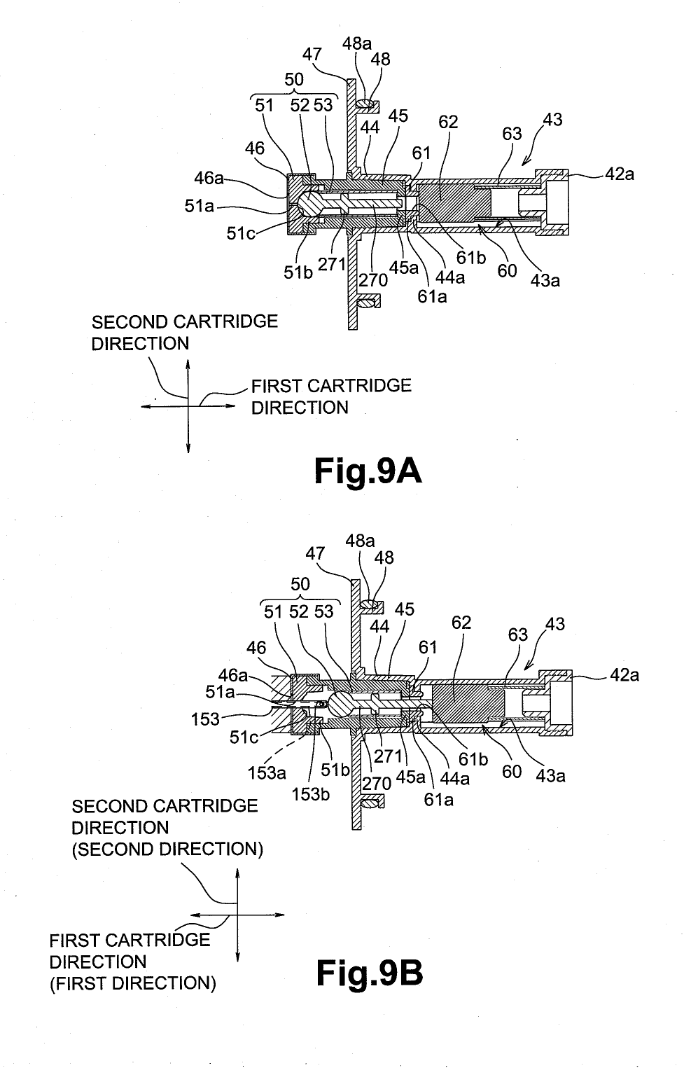

FIGS. 9A and 9B describe yet another embodiment of the invention, in which a pressing member 270 may be integral with the spherical member 52. Referring to FIG. 9A, the pressing member 270 may comprise a ring-shaped protrusion 271 extending from the outer surface of the pressing member 270 facing the inner surface of the coil spring 53, and the ring-shaped protrusion 271 may function as a guide for the movement of the pressing member 270 and the spherical member 52. Accordingly, referring to FIG. 9B, the pressing member 270 may move along the inner surface of the coil spring 53 in accordance with movement of the spherical member 52. Because the pressing member 270 is not integral with the valve member 62, the end of the valve member 62, which is configured to contact the valve seat 61 may be readily manufactured, e.g., ground or polished, with high precision, which may improve the close contact between the valve member 62 and the valve seat 61. On the other hand, in the embodiments described above, because the pressing member 70 is not integral with the spherical member 52 and is separated from the spherical member 52, the pressing member 70 may be easily manufactured, and therefore may operate in a stable manner with high precision.

In this embodiment, a gap may be formed between the pressing member 270 and the valve member 62 when the curved portion 51c and the spherical member 52 are in contact. This formed gap may have the same dimension in the first direction as the gap formed between the spherical member 52 and the pressing member 70, when the curved portion 51c and the spherical member 52 are in contact in the previously-described embodiment. Accordingly, the timings when the state of the first valve 50 transitions between the open state and the closed state and the state of the second valve 60 transitions between the open state and the closed state, are the same as in the previously described embodiment.

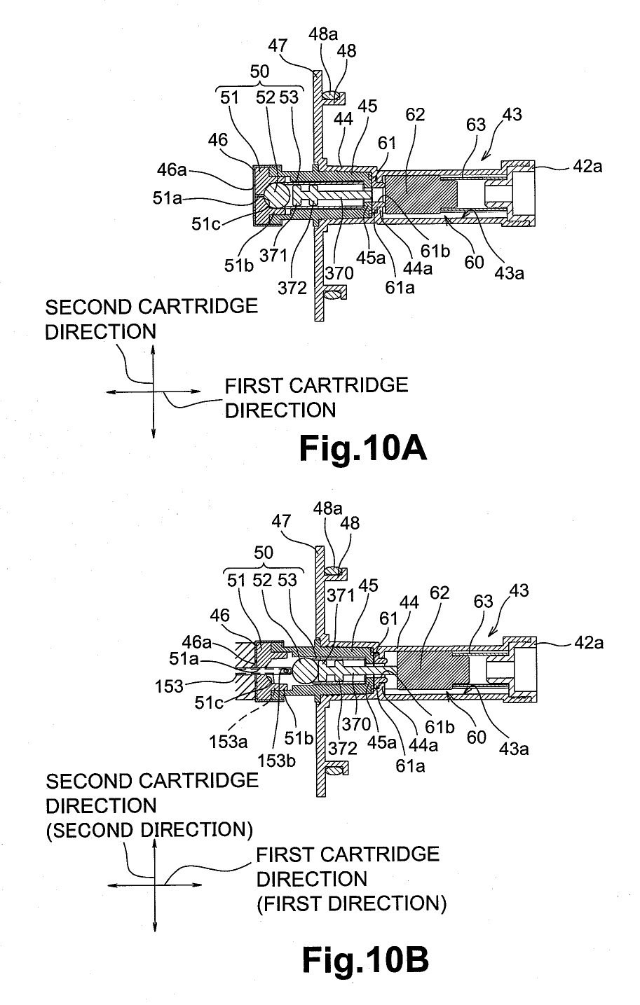

FIGS. 10A and 10B describe still yet another embodiment of the invention, in which a pressing member 370 may be integral with neither the spherical member 52 nor the valve member 62, i.e., the pressing member 370 may be a separate element from the first valve 50 and the second valve 60, and may be disposed between the spherical member 52 and the valve member 62. Accordingly, the end of the valve member 62 which is configured to contact the valve seat 61 may be easily manufactured, e.g., ground or polished, with high precision similarly to the previously described embodiment, thereby allowing high precision contact between the valve member 62 and the valve seat 61. Additionally, the pressing member 370 may be separated from the spherical member 52. Thus, the pressing member 370 may be manufactured similarly to the first embodiment. Referring to FIG. 10A, the pressing member 370 may comprise ring-shaped protrusions 371 and 372 extending from the outer surface of the pressing member 370, and facing the inner surface of the coil spring 53. The ring-shaped protrusions 371 and 372 may function as a guide for the movement of the pressing member 370. Thus, the pressing member 370 may move along the inner surface of the coil spring 53 in accordance with the movement of the spherical member 52 and movement of the valve member 62, as shown in FIG. 10B.

In this still yet another embodiment, the total length of the two gaps formed between the pressing member 370 and the spherical member 52 and between the spherical member 52 and the valve member 62 in the first direction when the curved portion 51c and the spherical member 52 are in contact is the same as the length of the gap formed between the spherical member 52 and the pressing member 70 in the first direction when the curved portion 51c and the spherical member 52 are in contact in the first embodiment. Accordingly, the timings when the state of the first valve 50 transitions between the open state and the closed state and when the state of the second valve 60 transitions between the open state and the closed state, are the same as in the first embodiment.

Because the previous two embodiments described above are different from the first described embodiment only in the structures of the pressing members 270 and 370, the dimension of the ring-shaped protrusion 51b or pressing members 270 and 370 in the first direction in the second and third modified embodiments may be greater than that in the first embodiment.

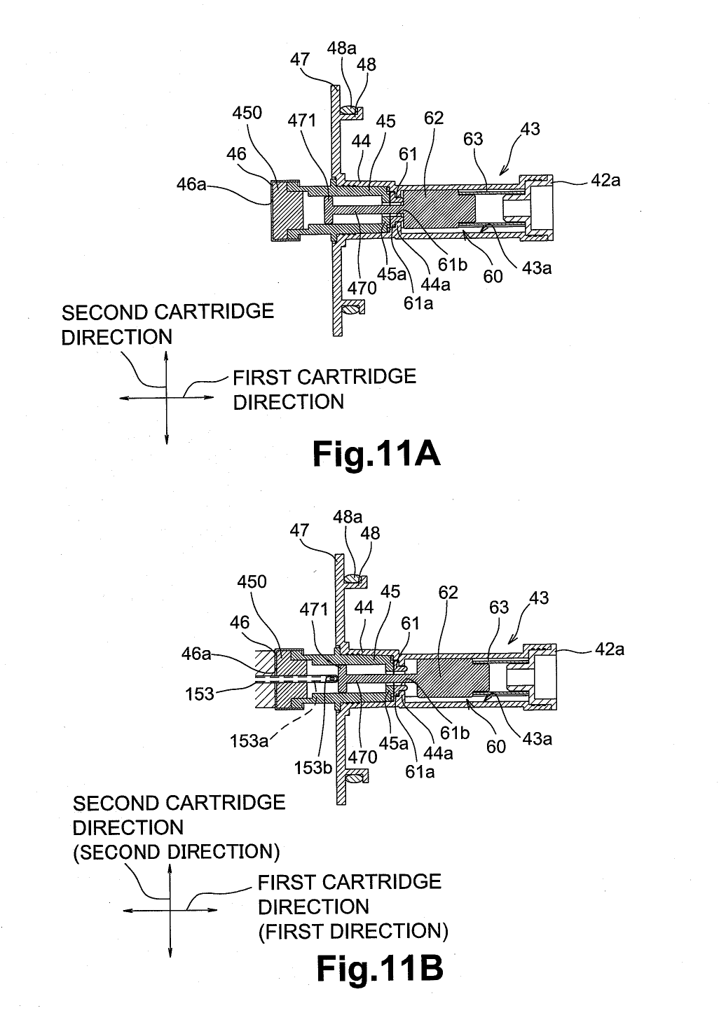

FIGS. 11A and 11B describe yet another embodiment of the invention, in which the first valve 50 may comprise a sealing member 450, which may be an elastic member positioned in the ink outlet path 43a. Sealing member 450 may contact the inner surface of the tube 45 to close the opening of the ink outlet path 43a formed at the second end of the ink outlet path 43a, and the first valve 50 does not comprise a spherical member and a coil spring. An opening is not formed through the sealing member 450. Accordingly, the number of parts used in the first valve may be reduced as compared to the previously described embodiments. In this embodiment, a pressing member 470 may comprises a wide-diameter portion 471 extending from the outer surface of the tip of the pressing member 470. The wide-diameter portion 471 may have a diameter slightly less than the inner diameter of the tube 45. Accordingly, referring to FIG. 11B, the pressing member 470 and the tip of the hollow tube 153 may come into contact in a stable manner. The sealing member 450 may comprise the same material as the sealing member 51 in the previously described embodiments.

In this embodiment, when the hollow tube 153 is inserted into the sealing member 450 for the first time, the sealing member 450, which may be acting as the first valve, may transition to the open state when the hollow tube 153 passes through the sealing member 450. Specifically, when the tip of the hollow tube 153 goes beyond the right end of the sealing member 450, sealing member 450 may be penetrated therethrough, thereby elastically deforming sealing member 450, i.e., compressing sealing member 450 to allow hollow tube 153 to pass therethrough, without removing any portion of sealing member 450. As shown in FIGS. 11A and 11B, the elastic deformation of sealing member 450 may transition the particular valve to the open state. However, once the hollow tube 153 has been removed from the sealing member 450 at least once, then when the hollow tube 153 is inserted into the sealing member 450 again, the sealing member 450 as the first valve becomes the open state when the tip of the hollow tube 153 is inserted into the sealing member 450, i.e., when the tip of the hollow tube 153 goes beyond the left end of the sealing member 450 in FIGS. 11A and 11B. More specifically, an opening may be formed through the sealing member 450 when the hollow tube 153 is inserted through the sealing member 450 for the first time, whereby the sealing member 450 transitions to the open state. When the hollow tube 153 is removed from the sealing member 450, the opening formed through the sealing member 450 may be closed off by the elastic force of the sealing member 450, by the sealing member 450 elastically reforming to seal the hole created by the penetration of hollow tube 153, thereby transitioning the particular valve to the closed state. When the hollow tube 153 is inserted into the sealing member 450 again, the opening of the sealing member 450 which has previously been closed, is opened by the insertion of the tip of the hollow tube 153 therein, and thereby the sealing member 450 may transition to the open state.

Referring to FIG. 11A, because a gap is formed between the sealing member 450 and the tip of the pressing member 470 in the first direction when the hollow tube 153 is not inserted into the sealing member 450, the second valve 60 may transition to the open state after the sealing member 450 as the first valve transitions to the open state.

When the hollow tube 153 is removed from the sealing member 450 from a state in which the hollow tube 153 is in the ink outlet path 43a and the valves 450 and 60 are in the open state, the second valve 60 transitions to the closed state first, and then the sealing member 450 transitions to the closed state when the hollow tube 153 is completely removed from the sealing member 450.

In this embodiment, the gap may be formed between the sealing member 450 and the tip of the pressing member 470 when the hollow tube 153 is not inserted into the sealing member 450. Nevertheless, in another embodiment, there may be no gap between the sealing member 450 and the tip of the pressing member 470 when the hollow tube 153 is not inserted into the sealing member 450. In other words, the sealing member 450 and the tip of the pressing member 470 may maintain contact when the hollow tube 153 is not inserted into the sealing member 450. In this case, when the hollow tube 153 comes into contact with the pressing member 470, the sealing member 450 as the first valve is already in the open state, and further insertion of the hollow tube 153 from this state causes the second valve 60 to transition to the open state. When the hollow tube 153 is removed from the sealing member 450, the sealing member 450 transitions to the closed state after the second valve 60 transitions to the closed state. Accordingly, the same advantages as in the first embodiment may be obtained as well.

Moreover, in still yet another embodiment, an opening may be originally formed through the sealing member 450 for the hollow tube 153 to be inserted thereinto. When the hollow tube 153 is not inserted into the sealing member 450, this opening may be closed by elastic force of the sealing member 450, and when the tip of the hollow tube 153 is inserted into the sealing member 450, the sealing member 450 as the first valve may transition to the open state. The sealing member 450 in this case may correspond to the sealing member 450, through which the hollow tube 153 has been inserted and removed at least once.

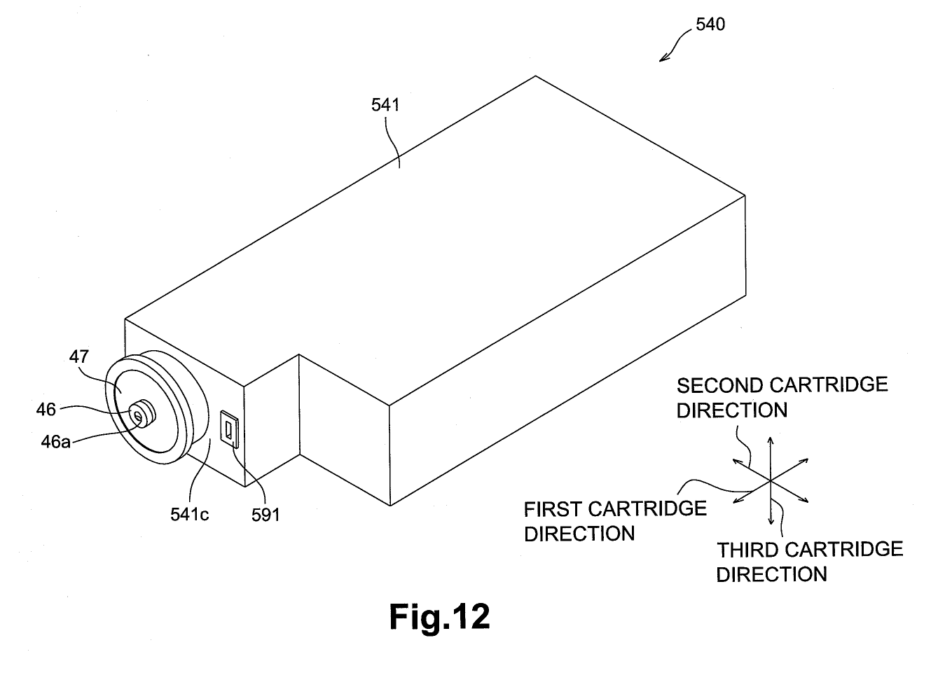

FIGS. 12 to 17B describe another embodiment of the invention. Components which are the same as or equivalent to those in the first embodiment will be denoted with the same reference numerals and description thereof will be omitted.

Referring to FIGS. 12 to 14, an ink cartridge 540 according to another embodiment may comprise a housing 541 having substantially a rectangular parallelepiped shape, an ink bag 42, an ink outlet tube 543, a first valve 50, a second valve 560, and an actuator 570. The interior of the housing 541 may be divided into two chambers 41a and 41b, similarly to the previously described embodiment. The ink bag 42 may be disposed in the chamber 41a and the ink outlet tube 543, the second valve 560, and the actuator 570 may be disposed in the chamber 41b. The chamber 41b in this another embodiment may be larger than the corresponding chamber described in the previous embodiment, because an electric power input portion 591, which will be described in more detail herein, may be disposed in the chamber 41b of the housing 541.

The ink outlet tube 543 may comprise a tube 548, e.g., a cylindrical tube 548, connected to the connecting portion 42a of the ink bag 42 at a first end of the tube 548. The ink outlet tube 543 also may comprise a tube 544 connected to a second end of the tube 548 at a first end of the tube 544, and a tube 45 fitted to a second end of the tube 544, thereby forming an ink outlet path 543a therein. More specifically, a first end of the tube 45 is fitted into the tube 544, but a second end of the tube 45 is positioned outside of the tube 544. The cylindrical tube 548 may be configured to elastically deform in its radial direction. The ink outlet tube 543 may extend in the first direction, and therefore the ink outlet path 543a defined by the ink outlet tube 543 also may extend in the first direction. The ink outlet path 543a may be configured to be in fluid communication with the interior of the ink bag 42 via the connecting portion 42a at a first end thereof, and to be in fluid communication with the outside of the ink cartridge 540 at a second end thereof The tube 544 substantially corresponds to the tube 44 of the previously described embodiment from which the portion where the second valve 60 is disposed is removed.

The housing 541 may comprise a shoulder surface 541c, which may be positioned away from the flange 47 toward the ink bag 42. The shoulder surface 541c may extend parallel with the flange 47, that is, the shoulder surface 541c may extend in the second direction and the third direction. The electric power input unit 591, as an example of a contact, may be provided on the shoulder surface 541c. The electric power input portion 591 may be positioned away from the ink discharge opening 46a in the second direction. Also, the electric power input portion 591 may be electrically connected to the actuator 570, and may be configured to supply electric power to the actuator 570 when the electric power input portion 591 is electrically connected to an electric power output portion 152, which will be described in more detail herein. In another embodiment, the electric power input portion 591 may be disposed at any position, that is not positioned directly below the ink discharge opening 46a when the ink cartridge 40 is mounted to a mounting portion 550. The electric power input portion 591 has a recess formed therein configured to receive the electric power output portion 152.

The electric power input portion 591 for transmitting electric power is not positioned directly below the ink discharge opening 46a, and thus ink dripping from the ink discharge opening 46a can be prevented from adhering to the electric power input portion 591. This may reduce the likelihood that electric power input portion 591 will short-circuit and damage the actuator 570. Also, because the electric power input portion 591 is provided on the shoulder surface 541 c, and there is a distance between the electric power input portion 591 and the ink discharge opening 46a in the first direction, the distance between the electric power input portion 591 and ink discharge opening 46a increases not only in the second direction but also in the first direction. Accordingly, adhesion of ink to the electric power input portion 591 may further be reduced.

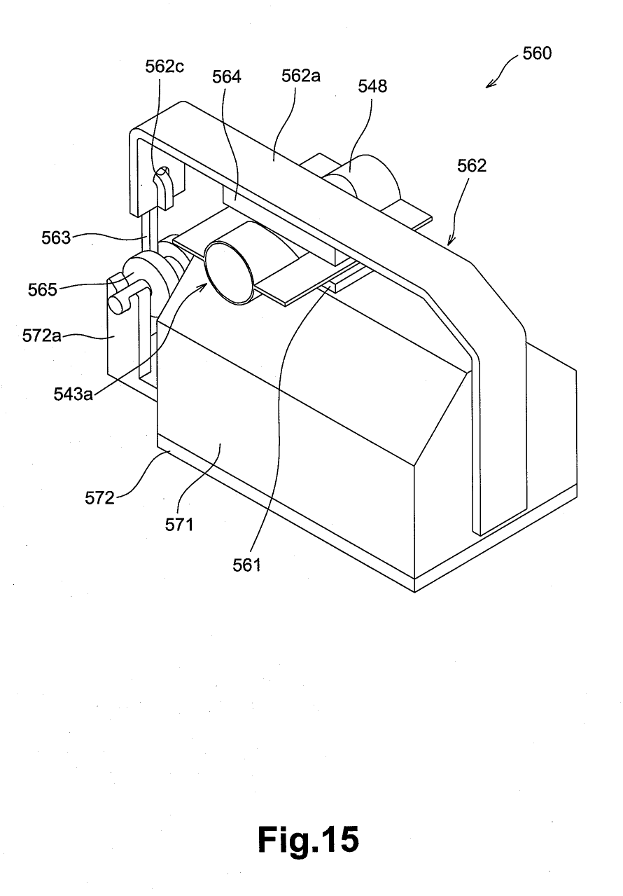

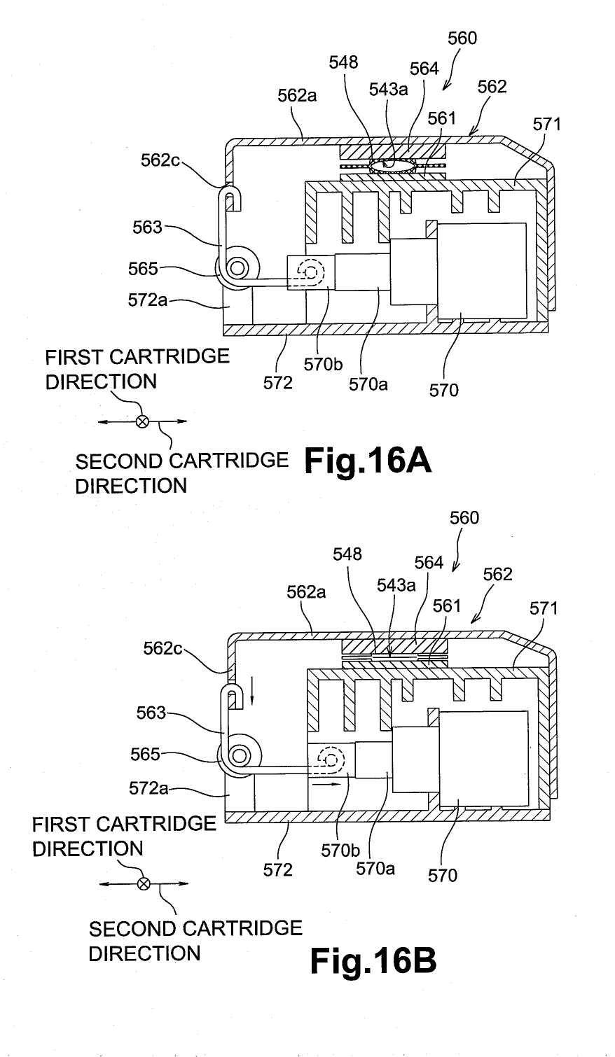

Referring to FIGS. 15 to 16B, the second valve 560 may comprise a rigid plate 561, a leaf spring 562 comprising a middle portion 562a, and the tube 548 may be positioned between the rigid plate 561 and the middle portion 562a of the leaf spring 562. The second valve 560 may comprise a wire 563 coupled to the actuator 570 at a first end thereof and to the leaf spring 562 at a second end thereof. The rigid member 561 may be disposed on a cover 571 covering the actuator 570.

The leaf spring 562 may be bent in a contour that follows the outer shape of the cover 571. A first end of the leaf spring 562 may be fixed to one side face of the cover 571, and a second end of the leaf spring 562 may move freely. The middle portion 562a of the leaf spring 562 may face the upper face of the cover 571 and may extend substantially parallel to the rigid plate 561 and the upper face of the cover 571. A plate shaped elastic member 564 comprising rubber or the like may be disposed between the middle portion 562a and the tube 548. An opening 562c may be formed through a portion of the leaf spring adjacent to the second end of the leaf spring 562. The second end of the wire 563 passes through the opening 562c, such that the wire 563 and the leaf spring 562 are coupled.

The actuator 570 may comprise a solenoid fixed to a base 572, and the solenoid may be configured, such that a movable core 570a may be linearly advanced and retracted. The actuator 570 may be driven such that when electric power is supplied thereto, the movable core 570a may be advanced, and when the electric power is no longer supplied thereto the movable core 570a may be retracted. Also, the actuator 570 may be covered by the cover 571 fixed to the base 572. A pair of supporting portions 572a may extend from the base 572 at a position facing the second end of the leaf spring 562. A pulley 565 may be rotatably supported by the pair of supporting portions 572a. A fixing portion 570b may be provided at the tip portion of the movable core 570a to which the first end of the wire 563 is fixed. The wire 563 may be bent over the pulley 565 such that the second end of the leaf spring 562 moves in accordance with operations of the actuator 570.

When the ink cartridge 540 is removed from a mounting portion 550, which will be described in more detail herein, the electric connection between the electric power input portion 591 and the electric power output portion 152 may be cut off, and electric power may not be not supplied to the actuator 570. The movable core 570a may be retracted from the position shown in FIG. 16A to the position shown in FIG. 16B, and the second end of the leaf spring 562 may moves downward in FIGS. 16A and 16B due to the force exerted by the wire 563. Specifically, the second end of the leaf spring 562 may move in such a direction that the tube 548 is pressed against the rigid plate 561 by the middle portion 562a of the leaf spring 562.

Accordingly, the leaf spring 562 may be elastically deformed so as to press the tube 548 between the middle portion 562a and the rigid plate 561. The tube 548 is elastically deformed in its radial direction to become flat, and thereby the second valve 560 transitions to a closed state, in which the second valve 560 prevents ink in the ink outlet path 543a from flowing via the second valve 560. When the ink cartridge 540 is mounted to the mounting portion 550, the electric power input portion 591 and the electric power output portion 152 may be electrically connected, and electric power is supplied to the actuator 570.

The movable core 570a may be advanced from the position shown in FIG. 16B to the position shown in FIG. 16A, and the middle portion 562a moves by the elastic force of the leaf spring 562 itself in a direction opposite to the direction to press the tube 548 against the rigid plate 561, i.e., the second end of the leaf spring 562 moves upwards in FIGS. 16A and 16B. Accordingly, pressing force applied to the tube 548 between the middle portion 562a and the rigid plate 561 is released, thereby the second valve 560 transitions to an open state, in which the second valve 560 allows ink in the ink outlet path 543a to flow via the second valve 560.

Thus, the second valve 560 may open and close the ink outlet path 543a without directly contacting ink in the ink outlet path 543a. This prevents the components of the second valve 560 from adhering to each other with thickened and dried ink. By disposing the wire 563 so as to be bent over the pulley 565, the second valve 560 and the actuator 570 may be arranged in a compact manner. Damage to the tube 548 due to opening and closing of the ink outlet path 543a by the second valve 560 may be reduced or eliminated because the elastic member 564 may be disposed between the leaf spring 562 and the tube 548.

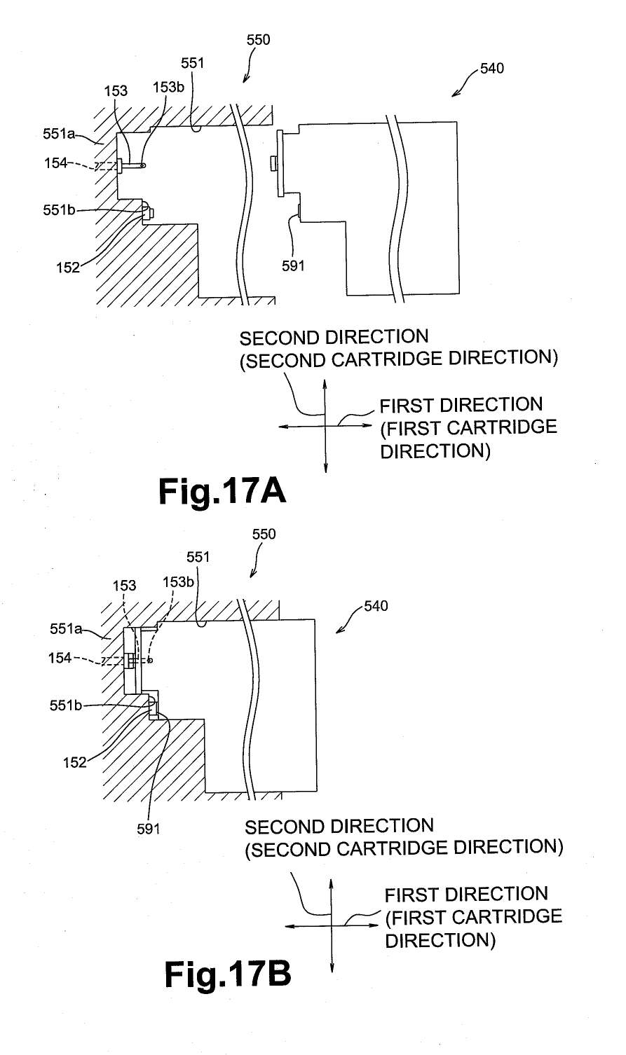

Referring to FIGS. 17A and 17B, the mounting portion 550 according to this embodiment is substantially the same as the mounting portion 150 in the previously described embodiment. The mounting portion 550 may have a recess 551 formed therein having a shape corresponding to the outer shape of the ink cartridge 540. The hollow tube 153 may be provided at a base portion 551a defining an end of the recess 551 in the second direction. The ink supply path 154 may be formed in the base portion 551a, and the electric power output portion 152 for outputting electric power from an electric power source (not shown) of the ink jet printer 1 is also provided at the base portion 551a.

The electric power output portion 152 may be disposed at a shoulder surface 551b formed on the base portion 551a. The electric power output portion 152 may extend from the shoulder surface 551b in the first direction, and is disposed at a position corresponding to the electric power input portion 591 when the ink cartridge 540 is mounted to the mounting portion 550. The electric power output portion 152 has a length such that the tip of the electric power output portion 152 may contact with the end of the electric power input portion 591 defining the bottom of the recess of the electric power input portion 591 when the ink cartridge 540 is mounted to the mounting portion 550 and the hollow tube 153 is completely inserted into the ink outlet tube 543. Specifically, after the first valve 50 transitions to the open state, the electric power output portion 152 and the electric power input portion 591 may be electrically connected, and electric power may be supplied to the actuator 570. Accordingly, the second valve 560 may transition to the open state after the first valve 50 transitions to the open state. Thus, in this second embodiment, when the ink cartridge 540 is mounted to the mounting portion 550, the second valve 560 transitions to the open state after the first valve 50 becomes the open state, as in previously-described embodiments.

When the ink cartridge 540 is removed from the mounting portion 550, such that the hollow tube 153 is removed from the ink outlet tube 543, the tip of the electric power output portion 152 moves away from the end the electric power input portion 591, and the supply of electric power to the actuator 570 stops. Accordingly, the second valve 560 transitions to the closed state before the first valve 50 transitions to the closed state. The hollow tube 153 further may move, such that the spherical member 52 and the ring-shaped protrusion 51b come into contact and the first valve 50 may transition to the closed state. Thus, at the time when the hollow tube 153 is removed from the sealing member 51 completely, the second valve 560 already is in the closed state, and the first valve 50 transitions to the closed state after the second valve 560 transitions to the closed state. Accordingly, the same advantages as in the previously described embodiments may be obtained. Also, even if a user inserts a rod-shaped object in the sealing member 51 instead of a hollow needle, the second valve 560 does not open, so there is no or little leakage from the ink cartridge 540. Also, because the second valve 560 operates electrically, there is no or little ink leakage from the ink cartridge 540 even if a user applies an external force to the ink cartridge 540, e.g., when a user drops the ink cartridge 540.

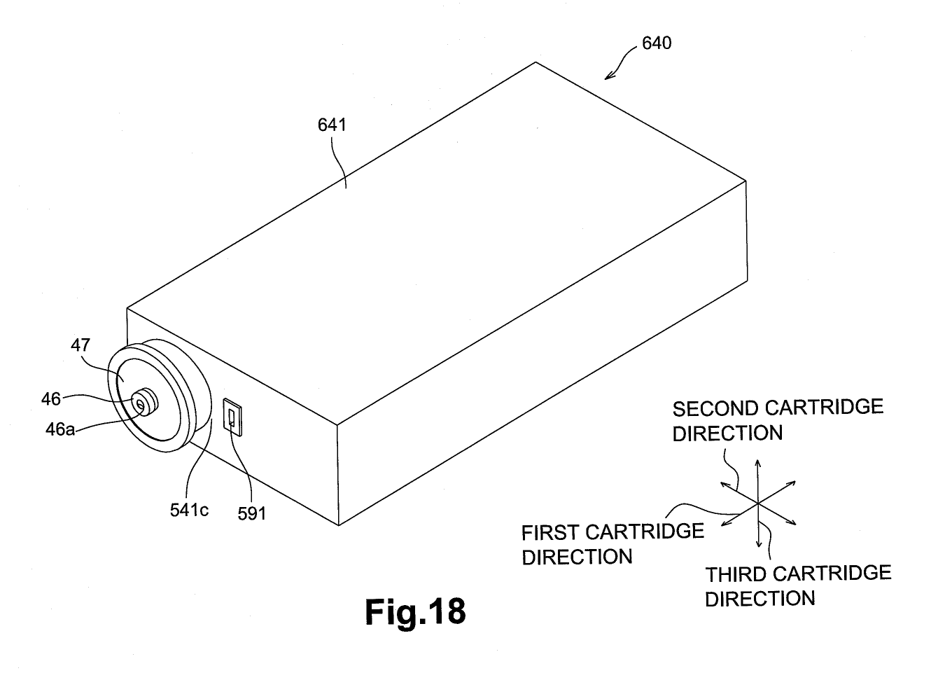

FIGS. 18 to 21B describe an ink cartridge according to a further embodiment of the invention. Components which are the same as or equivalent to those in the first and second embodiments will be denoted with the same reference numerals and description thereof will be omitted.

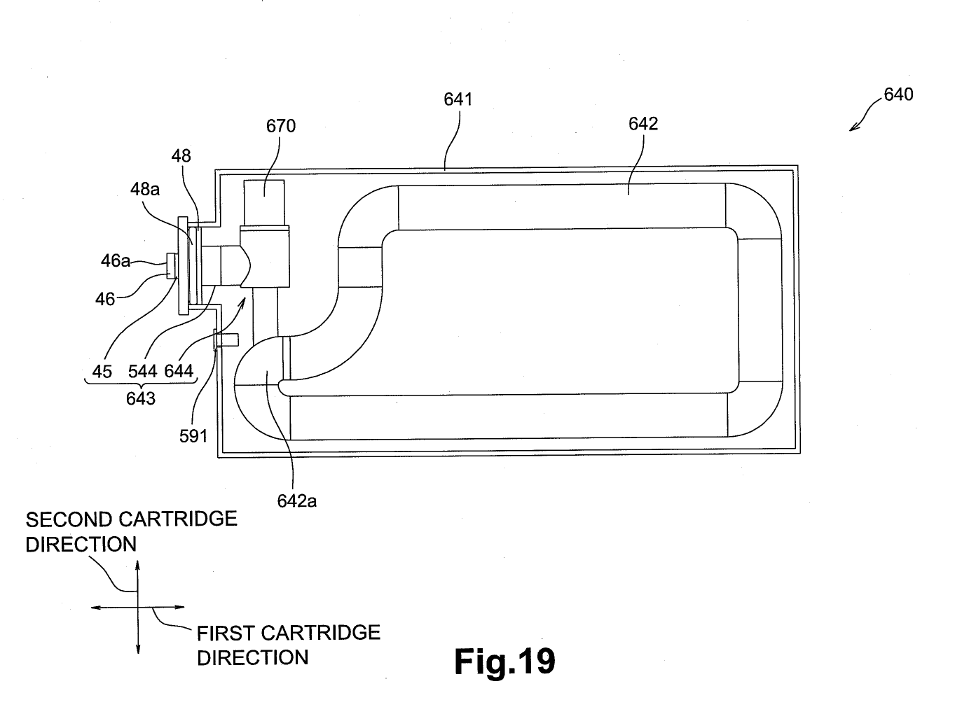

An ink cartridge 640 according to the further embodiment may comprise a housing 641 having substantially a rectangular parallelepiped shape, an ink bag 642 disposed in the housing 641 configured to store ink therein, an ink outlet tube 643 configured to be in fluid communication with the ink bag 642 at a first end thereof, a first valve 50, a second valve 660, and an actuator 670. The ink bag 642 may comprise a protruding portion 642a at the lower left portion thereof, which may protrudes to the left when positioned as shown in FIG. 19, and the first end of the ink outlet tube 643 may be connected to the protruding portion 642a.

The ink outlet tube 643 may comprise a tube 644 connected to the ink bag 642 at a first end, the tube 544, and a tube 45. The tube 644 may extend in the second direction and may form an ink outlet path 647a extending in the second direction. The tube 644 may comprise a small-diameter portion 644a and a large-diameter portion 644b, and the inner diameter of the large-diameter portion 644b is greater than the inner diameter of the small-diameter portion 644a. A lid 646 may be disposed at a second end of the tube 644 opposite the first end of the tube 644 in the second direction. The tube 544 and the tube 45 may extend in the first direction, and an ink outlet path 647b formed therein which also may extend in the first direction. The small-diameter portion 644a is connected to the ink bag 642, and the large-diameter portion 644b is connected to the first end of the tube 544, such that the ink outlet path 647a and an ink outlet path 647b are in fluid communication. Thus, the ink outlet tube 643 has an ink outlet path 647 formed therein, comprising the ink channels 647a and 647b in fluid communication with each other.

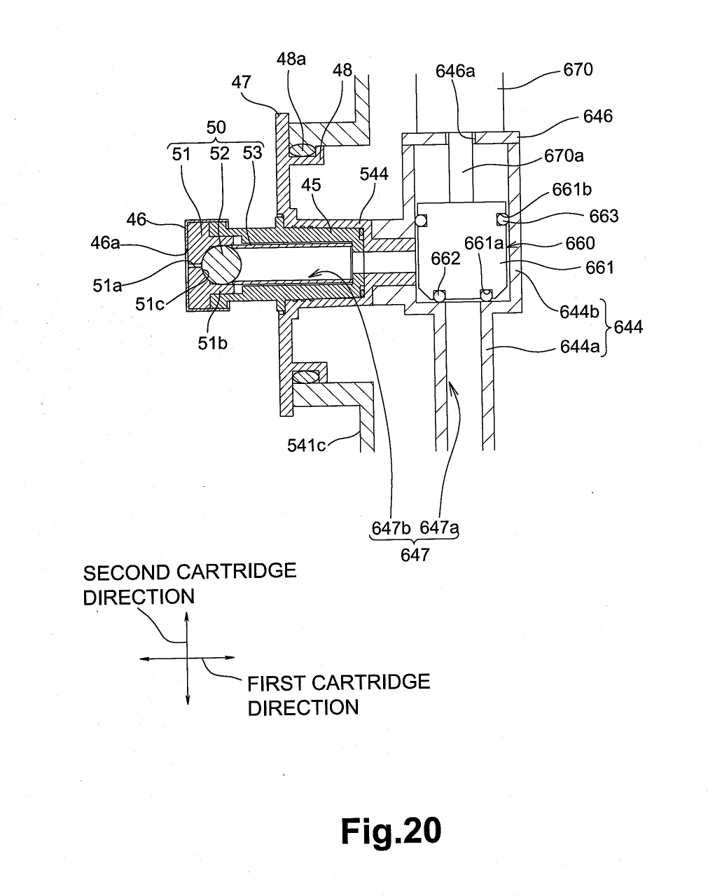

The second valve 660 may be disposed in the large-diameter portion 644b, and comprises a valve member 661, as a second valve member, having a cylindrical shape, and two O-rings 662 and 663 that may be configured to fill the gap between the valve member 661 and the inner surface of the large-diameter portion 644b. The valve member 661 may have a ring-shaped groove 661a formed in a surface of the valve member 661 facing the small-diameter portion 644a, e.g., the lower surface of the valve member 661 in FIG. 20, and a ring-shaped groove 661b formed in the side surface of the valve member 661 adjacent to the second end of the tube 644, e.g., an upper portion of the side surface of the valve member 661 in FIG. 20, with the o-rings 662 and 663 being disposed in the ring-shaped grooves 661a and 661b, respectively.

The ring-shaped groove 661a and the O-ring 662 may be disposed at the surface of the valve member 661, surrounding the portion of the valve member 661 facing the path formed in the small-diameter portion 644a. When the valve member 661 is in a closed position, e.g., a position where the O-ring 662 contacts the inner surface of the large-diameter portion 644b as shown in FIG. 20, the second valve 660 may be in a closed state, in which ink in the ink outlet path 647a may be prevented from flowing via the second valve 660.

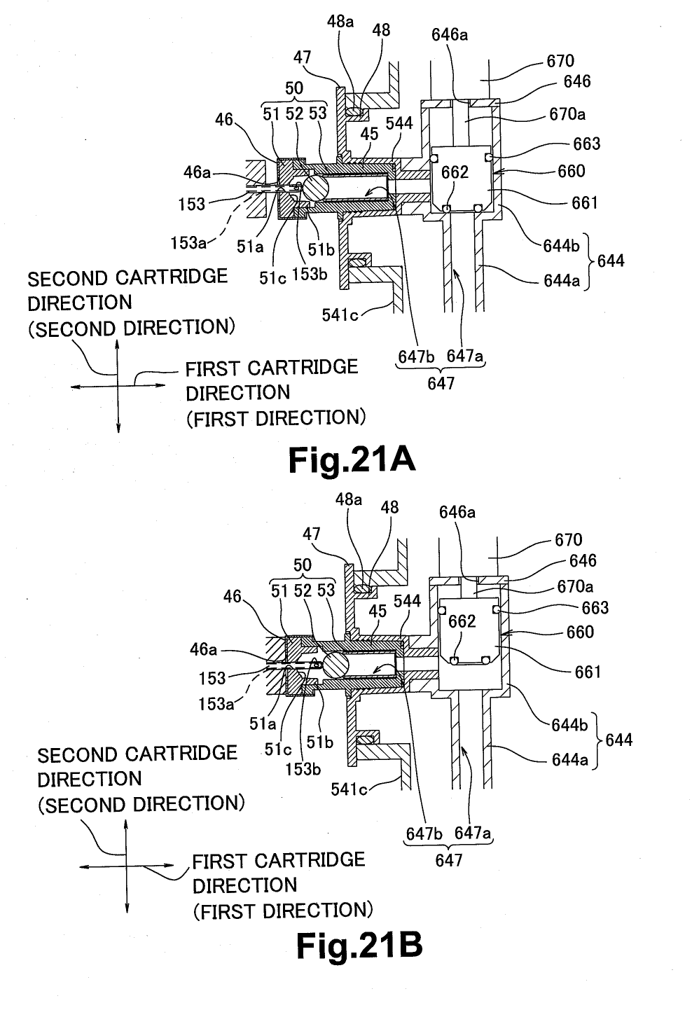

On the other hand, when the valve member 661 is in an open position, e.g., a position where the O-ring 662 is separated from the inner surface of the large-diameter portion 644b as shown in FIG. 21B, the second valve 660 may be in an open state, in which ink in the ink outlet path 647a is allowed to flow via the second valve 660 and the ink outlet path 647a and ink outlet path 647b are in fluid communication. Also, the regardless of whether valve member 661 is in the close position or the open position, the ring-shaped groove 661b and O-ring 663 are positioned closer to the lid 646 than the connection portion between the ink outlet path 647a and ink outlet path 647b are positioned to the lid 646. Accordingly, the connection portion between the ink outlet path 647a and ink outlet path 647b, and a space formed in the large-diameter portion 644b on the lid 646 side of the valve member 661, may not be in fluid communication due to the contact between the O-ring 663 and the inner surface of the large-diameter portion 644b.

As in the case of the actuator 570 in the previously described embodiment, the actuator 670 may comprise a solenoid configured, such that a movable core 670a may be linearly advanced and retracted. The actuator 670 may be electrically connected to the electric power input portion 591. The actuator 670 may be fixed on the lid 646 such that the moveable core 670a may pass through an opening 646a formed through the lid 646. The actuator 670 may be positioned externally from the ink outlet path 647a. Also, the tip of the moveable core 670a of the actuator 670 may be coupled to the valve member 661. The actuator 670 may be driven such that when electric power is supplied thereto the movable core 670a is retracted and when the electric power is not supplied thereto the movable core 670a is advanced.

When the ink cartridge 640 is removed from a mounting portion, the electric connection between the electric power input portion 591 and an electric power output portion provided in the mounting portion may be cut off, and electric power may not be supplied to the actuator 670. The movable core 670a may be advanced and the valve member 661 may move from the open position to the closed position. Thus, the second valve 660 may transition to the closed state. When the ink cartridge 640 is mounted to the mounting portion, the electric power input portion 591 and the electric power output unit portion may become electrically connected, and electric power may be supplied to the actuator 670. The movable core 670a then may be retracted and the valve member 661 may move from the closed position to the open position. Thus, the second valve 660 may transition to the open state.

In this further embodiment, as in the previously described embodiment, the electric power input portion 591 may be electrically connected to the electric power output portion when the ink cartridge 640 is mounted to the mounting portion and the hollow tube 153 is completely inserted into the ink outlet tube 643. More specifically, as shown in FIG. 21A, when the spherical member 52 is separated from the ring-shaped protrusion 51b due to the insertion of the hollow tube 153 into the sealing member 51, the electric power input portion 591 may not be electrically connected to the electric power output portion, and power may not be not supplied to the actuator 670, so the valve member 661 remains in the close position. When the hollow tube 153 is completely inserted as shown in FIG. 21B, the electric power input portion 591 may be electrically connected to the electric power output portion, and power may be supplied to the actuator 670. Accordingly, the actuator 670 may be driven and the valve member 661 moves to the open position, so the second valve 660 may transition to the open state. In this further embodiment, as in the previously described embodiments, when the ink cartridge 640 is mounted to the mounting portion, the second valve 660 transitions to the open state after the first valve 50 transitions to the open state.

When the ink cartridge 640 is removed from the mounting portion, the electric power output portion and the electric power input portion 591 may be separated and electric power supply to the actuator 670 stops, and subsequently the first valve 50 becomes the closed state. In other words, the second valve 660 may transition to the closed state before the first valve 50 transitions to the closed state. Thus, in this further embodiment, in the time in which the hollow tube 153 is removed from the sealing member 51 completely, the second valve 660 is already in the closed state, and the first valve 50 transitions to the closed state after the second valve 660 transitions to the closed state.

In some previous embodiments, the first valve transitions to the closed state after the second valve transitions to the closed state closed state when the ink cartridge is removed from the mounting portion. Nevertheless, the ring-shaped protrusion 51b can be made long in the first direction, such that the second valve transitions to the closed state after the first valve transitions to the closed state. In this case, when the ink cartridge is mounted to the mounting portion, the first valve transitions to the open state after the second valve transitions to the open state. In this case as well, even if the first valve is damaged when the ink cartridge is not mounted in the mounting portion, the second valve is in the closed state, so ink leakage can be reduced.

In some previous embodiments, when the ink cartridge is mounted to the mounting portion, the electric power output portion of the mounting portion and the electric power input portion of the ink cartridge can be electrically connected with each other before the first valve becomes the open state. In this further embodiment, when the ink cartridge is mounted to the mounting portion, the first valve may transition the open state after the second valve transitions to the open state, and when the ink cartridge is removed from the mounting portion, the second valve may transition to the closed state after the first valve transitions to the closed state. In this case as well, even if the first valve is damaged when the ink cartridge is not mounted in the mounting portion, the second valve is in the closed state, so ink leakage may be reduced.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An ink cartridge comprising:
an ink storing portion configured to store ink therein;
an ink outlet tube forming an ink outlet path configured to place an interior of the ink storing portion in fluid communication with an exterior of the ink storing portion, the ink outlet tube comprising:
a first outlet tube portion; and
a second outlet tube portion;
a particular valve comprising:
a sealing member configured to selectively close the particular valve by elastically deforming and reforming, and disposed at the first outlet tube portion;
a further valve disposed at the second outlet tube portion in the ink outlet path, the further valve comprising:
a further valve seat disposed at the second outlet tube portion separately formed from the sealing member and integrally formed with the second outlet tube portion, such that the further valve seat forms at least a portion of a wall at the second outlet tube portion,
a further valve member disposed at the second outlet tube portion, and configured to selectively contact and separate away from the further valve seat, to close and open the further valve, respectively, wherein the further valve member is configured to move in a moving direction that is substantially parallel to the first outlet tube portion and the second outlet tube portion, and the further valve member has at least one contact surface formed thereon facing the further valve seat;
a further biasing member disposed at the second outlet tube portion in the ink outlet path between the further valve member and the interior of the ink storing portion, the further biasing member comprising a first end and a second end opposite the first end, wherein the first end of the further biasing member contacts at least one surface of the further valve member opposite to the contact surface, and the second end of the further biasing member contacts a connection portion of the ink storing portion and the ink outlet tube, wherein the further biasing member is configured to bias the further valve member toward the particular valve and the further valve seat in a biasing direction that is substantially parallel to the moving direction, to close the further valve, and
wherein the particular valve is disposed between an exterior of the ink cartridge and the further valve.

2. The ink cartridge of claim 1, wherein the further valve seat is positioned away from the particular valve.

3. The ink cartridge of claim 1, wherein the further valve seat is formed completely of an inelastic material.

4. The ink cartridge of claim 1, further comprising a pressing member disposed between the further valve member and the sealing member, and configured to selectively press and move the further valve member away from the further valve seat in a direction opposite the biasing direction.

5. The ink cartridge of claim 4, wherein the pressing member is integrally formed with the further valve member.

6. The ink cartridge of claim 1, wherein the first outlet tube portion has a first interior width, the second outlet tube portion has a second interior width greater than the first interior width, the first outlet tube portion and the second outlet tube portion are contiguous, and the further valve member has a member width that is greater than the first interior width and less than the second interior width.

7. The ink cartridge of claim 6, wherein the further valve is configured to contact the further valve seat at a boundary between the first outlet tube portion and the second outlet tube portion.

8. The ink cartridge of claim 7, wherein the second width is defined at the boundary.

9. The ink cartridge of claim 1, wherein the sealing member is configured to transition from a first state to a second state, and to selectively transition between a second state and a third state, wherein
the sealing member is a continuously formed elastic member extending across the first outlet tube portion and configured to maintain the particular valve closed when the sealing member is in the first state, and the sealing member is configured to be separated and elastically deformed to open the particular valve when the sealing member is in the second state, and
when the sealing member is in the third state, the sealing member is configured to elastically reform to seal the portion of the sealing member that was separated when the sealing member was in the second state, such that the particular valve is closed when the sealing member is in the third state, and wherein the sealing member transitions from the first state to the second state when the sealing member is penetrated therethrough.

10. The ink cartridge of claim 9, wherein the sealing member transitions from the first state to the second state when the sealing member is initially penetrated therethrough, and wherein the sealing member transitions from the third state to the second state each time the sealing member is subsequently penetrated therethrough.
